(19) United States
(12) Patent Application Publication
(10) Pub. No.: US 2025/0059064 A1
(43) Pub. Date: Feb. 20, 2025

(54) Porous Pipes for Wastewater Treatments

(71) Applicant: Exotex, Inc., Houston, TX (US)

(72) Inventor: Michael J. Parrella, Katy, TX (US)

(21) Appl. No.: 18/719,228

(22) PCT Filed: Dec. 14, 2022
(86) PCT No.: PCT/US2022/081571

§ 371 Date: Jun. 12, 2024

Related U.S. Application Data
(60) Provisional application No. 63/289,369, filed on Dec. 14, 2021.

(51) Int. Cl. C02F 1/00; C02F 1/32; C02F 1/74

(52) U.S. Cl. CPC C02F 1/001; C02F 1/32; C02F 1/74; C02F 2201/004; C02F 2303/24

(57) ABSTRACT

The present application provides for a porous pipe filtering and processing system for wastewater. A plurality of porous pipes is provided comprising pores in the outer walls of progressively decreasing size, which filter particulates from the wastewater sequentially. The porous pipes for filtering can be provided concentrically or in a serial module format wherein each module discharges a filtered output to the subsequent module.

### CROSS-REFERENCE TO RELATED APPLICATIONS

The present application claims the benefit of U.S. Provisional Patent Application No. 63/289,369 filed Dec. 14, 2021, which is hereby incorporated by reference in its entirety.

### BACKGROUND OF THE DISCLOSURE

Wastewater is used water, and includes substances such as human waste, food scraps, oils, soaps, and chemicals. In homes, this includes water from sinks, showers, bathtubs, toilets, washing machines and dishwashers. Businesses and industries also contribute water that must be cleaned.

Nature can cope with small amounts of water waste and pollution, but it would be overwhelmed if the billions of gallons of wastewater and sewage produced every day were not treated before releasing it back to the environment. Treatment plants reduce pollutants in wastewater to a level nature can handle. But harmful substances wash off roads, parking lots, and rooftops can harm our rivers and lakes.

There are many good reasons why keeping water clean is an important priority. Clean water is critical to plants and animals that live in water. This is important to the fishing industry, sport fishing enthusiasts, and future generations. Rivers and ocean waters teem with life that depends on shoreline, beaches, and marshes. They are critical habitats for species of fish and other aquatic life. Migratory water birds use the areas for resting and feeding. The scenic and recreational values of waters are reasons many people choose to live where they do. Visitors are drawn to water activities such as swimming, fishing, boating, and picnicking. If it is not properly cleaned, water can carry disease and harmful bacteria have to be removed to make water safe.

There are several steps involved in traditional wastewater treatment methods. First, a preliminary treatment can be provided to remove materials that can cause operational problems. Equalization basins may be optionally used in such preliminary treatment.

Primary treatment of wastewater involves sedimentation of solid waste within the water. This primary treatment step removes about 60% of solids and 35% of biological oxygen demand (BOD). This is done after filtering out larger contaminants within the water. Wastewater is passed through several tanks and filters that separate water from contaminants. The resulting “sludge” is then fed into a digester, in which further processing takes place. This primary batch of sludge contains nearly 50% of the suspended solids within wastewater.

Secondary treatment of wastewater makes use of oxidation to further purify wastewater. This can be done in one of three ways: (1) Biofiltration, which is a method of secondary treatment of wastewater employs sand filters, contact filters to ensure that additional sediment is removed from wastewater. Of the three filters, trickling filters are typically the most effective for small-batch wastewater treatment; (2) Aeration, which is a long, but effective process that entails mixing wastewater with a solution of microorganisms. The resulting mixture is then aerated for up to thirty hours at a time to ensure results; (3) Oxidation Ponds, which are typically used in warmer places. In addition, this method utilizes natural bodies of water like lagoons. Wastewater is allowed to pass through this body for a period of time and is then retained for two to three weeks. The secondary treatment stage removes approximately 85% of solids and BOD.

Tertiary wastewater treatment, the third and possibly last step in the basic wastewater management systems, is mostly comprised of removing phosphates and nitrates from the water supply, and removal of remaining BOD and solids. Substances like activated carbon and sand are among the most commonly used materials that assist in this process. Further, there may be a final treatment step for disinfection and a solids processing step for sludge management. Wastewater treatment may entail more than these steps, but these are the basis of how traditional wastewater treatment facilities operate.

If wastewater is not properly treated, then the environment and human health can be negatively impacted. These impacts can include harm to fish and wildlife populations, oxygen depletion, beach closures and other restrictions on recreational water use, restrictions on fish and shellfish harvesting and contamination of drinking water, such as: decaying organic matter and debris using the dissolved oxygen in a lake so fish and other aquatic biota cannot survive; excessive nutrients, such as phosphorus and nitrogen (including ammonia), can cause eutrophication, or over-fertilization of receiving waters, which can be toxic to aquatic organisms, promote excessive plant growth, reduce available oxygen, harm spawning grounds, alter habitat and lead to a decline in certain species; chlorine compounds and inorganic chloramines can be toxic to aquatic invertebrates, algae and fish; bacteria, viruses and disease-causing pathogens can pollute beaches and contaminate shellfish populations, leading to restrictions on human recreation, drinking water consumption and shellfish consumption; metals, such as mercury, lead, cadmium, chromium and arsenic can have acute and chronic toxic effects on species; and other substances such as some pharmaceutical and personal care products, primarily entering the environment in wastewater effluents, may also pose threats to human health, aquatic life and wildlife.

FIG. 1 shows an example of conventional wastewater treatment plant schematic. The system includes several steps or components. A collection system 21 collects wastewater/sewage from homes, commercial businesses, and industrial facilities that flows into the treatment plant through miles of underground sewer pipeline. Most of the pipes to the collection system 21 slope downward to allow the wastewater to flow by gravity. For areas where gravity cannot be relied on, the wastewater is pumped up and over hills by strategically located pumping stations. The system of sewers must be continually cleaned and maintained to transport the wastewater to the plant.

A pretreatment system 22 is also included, and after entering the pretreatment system 22, wastewater passes through bar screens where large objects such as rags, branches, and various other floating objects are removed. Screenings can be disposed of in a landfill 26.

A primary treatment system 23 is provided, which includes a pre-aeration, grit removal system 23a and primary sedimentation tanks 23b. Grit (inorganic material such as sand, gravel, and metal shaving, and non-degradable organic material such as coffee grounds, eggshells, and hard-shelled seeds) is removed by the grit removal system 23a. The grit is washed and dewatered by the solids processing system 25 prior to disposal in a landfill 26. Removal of screenings and grit from the wastewater helps to protect mechanical equipment and pumps from abnormal wear and prevents clogged pipes in the plant. Next, the wastewater is pumped to primary sedimentation tanks 23b, also known as primary clarifiers, which are large sedimentation tanks where material that floats (scum) is skimmed from the water surface, and material that settles (sludge) is scraped from the tank bottom. The settled material, called primary sludge, is pumped to the solids processing system 25 for further processing.

A secondary treatment system 24 is also provided, including an aeration system 24a and secondary sedimentation tanks 24b. Following primary sedimentation, the wastewater enters aeration tanks 24a where microscopic organisms break down and feed off dissolved organic wastes and material that neither sinks nor floats. Similar to the primary sedimentation process, scum is skimmed off the water surface by the secondary sedimentation tanks 24b, while blades scrape the solids from the bottom of the secondary sedimentation tanks 24b. To maintain an adequate population of microbes in the aeration basins 24a, a portion of the settled solids are returned to the aeration basins 24a, and the remainder is sent to the solids processing system 25.

The solids processing system 25 may include components such as a sludge thickener system, a digester system, a sludge dewatering system, and a grid washing and dewatering system. Solids collected from the secondary sedimentation tank 24b are sent to a sludge thickener to remove water. The thickened sludge, along with primary sludge, next enters digesters, which are large, heated mechanical devices in which anaerobic microorganisms break down the sludge solids into stable compounds. Digested sludge, also known as bio-solids, still contains a significant amount of water, and can be provided to a sludge dewatering system, where belt presses squeeze out excess moisture, reducing the volume of the bio-solids. The dewatered bio-solids are trucked to a landfill.

The clarified water is provided from the secondary sedimentation tank 24b to a disinfection system 27, where sodium hypochlorite is used to disinfect the treated wastewater. The disinfected and dechlorinated water 29a can be safely output to a body of water. Some of the clarified water is also provided from the secondary sedimentation tank 24b a tertiary treatment plant 28, which may comprise a tertiary filter and an ultraviolet radiation system, to output recycled water 29b for storage, irrigation, or other uses.

### SUMMARY OF THE DISCLOSURE

The present application provides for a porous pipe filtering and processing system for wastewater. Porous pipe is made from composites that resist corrosion and erosion. The pipe is produced so that the inside and outside surface area allows for fluid flow. The amount of flow is contingent on the size of the flow paths through pores in the wall of the pipe and the pressure differential between the inside of the pipe and the outside of the pipe. The pressure characteristics also determine the direction of the flow. Any particle that is larger than the diameter of the flow path will not flow thru the porous pipe. The porous pipe can be used to filter different size particulate depending on flow path size of the pipe. A flow path can vary from millimeters to microns in diameter. By using porous pipes in combination with other technologies, wastewater treatment can be improved and capital for implementation can be reduced.

The porous pipe wastewater filtering and processing systems described herein create a single step process that eliminates the requirement for several of the steps and systems shown in the prior art system of FIG. 1, including the elimination of the pretreatment system 22, primary system 23, secondary system 24, disinfection system 27 and tertiary water system 28, and the machinery, equipment, and energy consumption required by them. The porous pipe filtering system filters particulate, treats bacteria, treats viruses, aerates, sanitizes by applying heat, sanitizes by applying ultraviolet radiation, and optionally uses chemicals, all as part of an integrated system. The porous pipe filtering system of the present application can remove over 90% of suspended solids in wastewater, including those over 1 micron. With the porous pipe filtering system of the present application, a single integrated system takes advantage of functional synergies that do not exist with separate processing steps.

An example of the porous pipe used in the systems described herein may include the pipes described in U.S. patent application Ser. No. 15/552,868 filed Aug. 23, 2017, which is hereby incorporated by reference in its entirety. Although the present application is not limited to a particular type or material of porous pipe, the porous pipes described herein can be fibrous porous pipes as described in the aforementioned prior application, where the amount of porosity can determined by the weave, knit, braid or spin, and the size of the flow paths created. The pipe may be porous substantially across its entire surface area, flow of fluids through the pipe is increased and maximized. Using a fiber such as micron basalt filament or E-glass in a weaving, braiding, or spinning process with the proper epoxy resin, various products can be created that have porous flow paths for fluids along the entire surface area.

The porous pipe filtering system of the present application combines, and improves upon primary, secondary, and partial tertiary conventional wastewater processing. The porous pipe wastewater treatment systems and processes of the present application may include the following features, separately or in combination: advanced single and multi-stage filtering using porous pipes; separation of particulate sludge by size; integrated ultraviolet treatment; integrated heat treatment; integrated aeration using a porous pipe to aerate; integrated chemical treatment with advanced chemical mixing; pulsing the effluent flows and using vibration to move the particulate, break up soft particulate, increase the efficiency of aeration, increases the efficiency of ultraviolet radiation, and increase the efficiency of heat treatment and chemicals distribution; controlling frequency and phase of the pulses and vibrations allowing for constructive interference improving use of power; vibration of the walls of the porous pipe and the walls of the collection chambers to reduce clogging, move the particulate and break up soft particulate; rotating the porous pipe to reduce clogging; using exhaust heat from the generation of electricity to sanitize the effluent; using a comprehensive control system to manage and optimize the performance of the system; building each phase as a module that is shipped by truck and assembled in the field; and design so gravity assists the particulate and effluent flow optimizing power utilization.

In accordance with a first aspect of the present application, a water filtration system is provided, comprising a first treatment system comprising a first collection chamber, and a first porous pipe, arranged in the first collection chamber, having pores of a first porosity size and configured to receive a water input including water and particulate matter. The water input is configured to flow through the pores of the first porous pipe and provide a first filtered sludge into the first collection chamber while the pores of the first porous pipe block a first portion of the particulate matter having solid particulates greater in size than the first porosity size from passing into the first collection chamber. The water filtration system may further comprise a second treatment system comprising: a second collection chamber; and a second porous pipe, arranged in the second collection chamber, with pores of a second porosity size and configured to receive the first filtered sludge from the first treatment system, where the second porosity size is smaller than the first porosity size and the first filtered sludge is configured to flow through the pores of the second porous pipe and to provide a second filtered fluid while the pores of the second porous pipe block a second portion of the particulate matter including solid particulates greater in size than the second porosity size from passing through the second porous pipe.

Implementations of the water filtration system of the first aspect of the application may include one or more of the following features. The second filtered fluid may be a second filtered sludge, and the second filtered sludge passes into the second collection chamber. The second treatment system further may include: a third collection chamber; and a third porous pipe, arranged in the third collection chamber, having pores of a third porosity size and configured to receive the second filtered sludge from the second collection chamber, where the third porosity size is smaller than the second porosity size. The second filtered sludge is configured to flow through the pores of the third porous pipe and provide a third filtered fluid while the pores of the third porous pipe block a third portion of the particulate matter including solid particulates greater in size than the third porosity size from passing through the third porous pipe. The third filtered fluid can be a third filtered sludge that passes into the third collection chamber. The second treatment system further may include: a fourth collection chamber; and a fourth porous pipe, arranged in the fourth collection chamber, with pores of a fourth porosity size and configured to receive the third filtered sludge from the third collection chamber, where the fourth porosity size is smaller than the third porosity size. The third filtered sludge is configured to flow through the pores of the fourth porous pipe and provide a fourth filtered fluid into the fourth collection chamber while the pores of the third porous pipe block a fourth portion of the particulate matter may include solid particulates greater in size than the fourth porosity size from passing through the fourth porous pipe.

One or more of the first porous pipe, the second porous pipe, the third porous pipe and the fourth porous pipe can be provided with a vibration transducer configured to vibrate the respective porous pipe. One or more of the first collection chamber, the second collection chamber, the third collection chamber and the fourth collection chamber can be provided with a vibration transducer configured to vibrate the respective collection chamber. Each of the first porous pipe, the second porous pipe, the third porous pipe and the fourth porous pipe may include a pump system comprising one or more pumps and oscillators configured to create positive pulsing pressure pulling input into the respective porous pipe, and to create negative pulsing pressure pushing output from a preceding fluid source. One or more of the first collection chamber, the second collection chamber, the third collection chamber and the fourth collection chamber may include one or more of: an ultraviolet radiator therein; an aeration supply system therein, the aeration supply system having a further porous pipe configured to receive an input of air and provide the air through pores of the further porous pipe into the respective collection chamber; a chemical supply system therein, the chemical supply system having a further porous pipe configured to receive an input of one or more chemicals and provide the one or more chemicals through pores of the further porous pipe into the respective collection chamber; and an aeration and chemical supply system therein, the aeration and chemical supply system having a further porous pipe configured to receive an input of air and one or more chemicals and provide the air and the one or more chemicals through pores of the further porous pipe into the respective collection chamber. The water filtration system may also include a tertiary treatment system receiving an input of the second filtered fluid, the third filtered fluid, or the fourth filtered fluid, and comprising one or more of an activated carbon filtration system, an ion exchange system, and a reverse osmosis system configured to process the input. Each of the first porous pipe, the second porous pipe, the third porous pipe and the fourth porous pipe and the first collection chamber, the second collection chamber, the third collection chamber and the fourth collection chamber include a downward slope in a direction of fluid flow.

In additional embodiments of the water filtration system of the second aspect of the present application, the second filtered fluid is a second filtered sludge, and the second treatment system further may include: a third porous pipe, arranged around the second porous pipe, with pores of a third porosity size and configured to receive the second filtered sludge from the second porous pipe, where the third porosity size is smaller than the second porosity size. The second filtered sludge is configured to flow through the pores of the second porous pipe and to provide a third filtered fluid while the pores of the third porous pipe block a third portion of the particulate matter with solid particulates greater in size than the third porosity size from passing through the third porous pipe. The third filtered fluid can be a third filtered sludge, and the second treatment system further may include: a fourth porous pipe, arranged around the third porous pipe, with pores of a fourth porosity size and configured to receive the third filtered sludge from the third porous pipe, where the fourth porosity size is smaller than the third porosity size. The third filtered sludge is configured to flow through the pores of the fourth porous pipe and to provide a fourth filtered fluid while the pores of the fourth porous pipe block a fourth portion of the particulate matter with solid particulates greater in size than the fourth porosity size from passing through the fourth porous pipe. The fourth filtered fluid passes into the second collection chamber.

One or more of the first porous pipe, the second porous pipe, the third porous pipe and the fourth porous pipe can be provided with a vibration transducer configured to vibrate the respective porous pipe. One or both of the first collection chamber and the second collection chamber can be provided with: a vibration transducer configured to vibrate the respective collection chamber; a pump system comprising one or more pumps and oscillators configured to create positive pulsing pressure pulling input into the respective collection chamber, and to create negative pulsing pressure pushing output from a preceding fluid source; an ultraviolet radiator therein; an aeration supply system therein comprising a further porous pipe configured to receive an input of air and provide the air through pores of the further porous pipe into the respective collection chamber; a chemical supply system therein comprising a further porous pipe configured to receive an input of one or more chemicals and provide the one or more chemicals through pores of the further porous pipe into the respective collection chamber; and/or an aeration and chemical supply system therein, comprising a further porous pipe configured to receive an input of air and one or more chemicals and provide the air and the one or more chemicals through pores of the further porous pipe into the respective collection chamber. The water filtration system may also include a tertiary treatment system receiving an input of the second filtered fluid, the third filtered fluid, or the fourth filtered fluid, comprising one or more of an activated carbon filtration system, an ion exchange system, and a reverse osmosis system configured to process the input.

In accordance a second aspect of the present application, a water filtration method is provided. The water filtration method comprises a first treatment process including: providing a water input comprising water and particulate matter to a first treatment system. The first treatment system comprises a first collection chamber and a first porous pipe, arranged in the first collection chamber, with pores of a first porosity size and configured to receive the water input, where the water input is configured to flow through the pores of the first porous pipe and provide a first filtered sludge into the first collection chamber while the pores of the first porous pipe block a first portion of the particulate matter with solid particulates greater in size than the first porosity size from passing into the first collection chamber. The water filtration method further comprises a second treatment process including: providing the first filtered sludge to a second collection chamber and a second porous pipe, arranged in the second collection chamber, having pores of a second porosity size and configured to receive the first filtered sludge, where the second porosity size is smaller than the first porosity size, and where the first filtered sludge is configured to flow through the pores of the second porous pipe and to provide a second filtered fluid while the pores of the second porous pipe block a second portion of the particulate matter having solid particulates greater in size than the second porosity size from passing through the second porous pipe.

Implementations of the water filtration method of the second aspect of the present application may include one or more of the following features. The second filtered fluid can be a second filtered sludge, and the second filtered sludge passes into the second collection chamber. The second treatment process further may include providing the second filtered sludge from the second collection chamber to a third porous pipe arranged in a third collection chamber, the third porous pipe having pores of a third porosity size, where the third porosity size is smaller than the second porosity size, and where the second filtered sludge is configured to flow through the pores of the third porous pipe and to provide a third filtered fluid while the pores of the third porous pipe block a third portion of the particulate matter with solid particulates greater in size than the third porosity size from passing through the third porous pipe. The third filtered fluid can be a third filtered sludge that passes into the third collection chamber. The second treatment process further may include providing the third filtered sludge from the third collection chamber to a fourth porous pipe arranged in a fourth collection chamber, the fourth porous pipe with pores of a fourth porosity size, which is smaller than the third porosity size; and where the third filtered sludge is configured to flow through the pores of the fourth porous pipe and to provide a fourth filtered fluid into the fourth collection chamber while the pores of the third porous pipe block a fourth portion of the particulate matter with solid particulates greater in size than the fourth porosity size from passing through the fourth porous pipe.

The water filtration method may include vibrating, by a vibration transducer arranged thereon, one or more of the first porous pipe, the second porous pipe, the third porous pipe and the fourth porous pipe. The water filtration method may include vibrating, by a vibration transducer arranged thereon, one or more of the first collection chamber, the second collection chamber, the third collection chamber and the fourth collection chamber. Each of the first porous pipe, the second porous pipe, the third porous pipe and the fourth porous pipe may include a pump system comprising one or more pumps and oscillators configured to create positive pulsing pressure pulling input into the respective porous pipe, and to create negative pulsing pressure pushing output from a preceding fluid source. The water filtration method may include providing ultraviolet radiation within one or more of the first collection chamber, the second collection chamber, the third collection chamber and the fourth collection chamber. The water filtration method may further include aerating, by an aeration supply system arranged therein, one or more of the first collection chamber, the second collection chamber, the third collection chamber and the fourth collection chamber, the aeration supply system may include a further porous pipe configured to receive an input of air and provide the air through pores of the further porous pipe into the respective collection chamber. The method may further comprise supplying one or more chemicals by a chemical supply system arranged in the respective collection chamber, the chemical supply system may include a further porous pipe configured to receive an input of the one or more chemicals and provide the one or more chemicals through pores of the further porous pipe into the respective collection chamber. One or more of the first collection chamber, the second collection chamber, the third collection chamber and the fourth collection chamber may include an aeration and chemical supply system therein comprising a further porous pipe configured to receive an input of air and one or more chemicals and provide the air and the one or more chemicals through pores of the further porous pipe into the respective collection chamber. The water filtration method may further include a tertiary treatment process comprising processing one or more of the second filtered fluid, the third filtered fluid, or the fourth filtered fluid with one or more of an activated carbon filtration process, an ion exchange process, and a reverse osmosis process. Each of the first porous pipe, the second porous pipe, the third porous pipe and the fourth porous pipe and the first collection chamber, the second collection chamber, the third collection chamber and the fourth collection chamber may include a downward slope in a direction of fluid flow.

In additional embodiments of the water filtration method of the second aspect of the present application, the second filtered fluid is a second filtered sludge, and the second treatment process further may include providing the second filtered sludge to a third porous pipe, arranged around the second porous pipe, with pores of a third porosity size, where the third porosity size is smaller than the second porosity size. The second filtered sludge is configured to flow through the pores of the second porous pipe and to provide a third filtered fluid while the pores of the third porous pipe block a third portion of the particulate matter with solid particulates greater in size than the third porosity size from passing through the third porous pipe. The third filtered fluid is a third filtered sludge, and the second treatment process further may include providing the third filtered sludge to a fourth porous pipe, arranged around the third porous pipe, with pores of a fourth porosity size, where the fourth porosity size is smaller than the third porosity size. The third filtered sludge is configured to flow through the pores of the fourth porous pipe and to provide a fourth filtered fluid while the pores of the fourth porous pipe block a fourth portion of the particulate matter with solid particulates greater in size than the fourth porosity size from passing through the fourth porous pipe. The fourth filtered fluid passes into the second collection chamber.

The water filtration method may further include vibrating, by a vibration transducer arranged thereon, one or more of the first porous pipe, the second porous pipe, the third porous pipe and the fourth porous pipe. The water filtration method may further include vibrating, by a vibration transducer arranged thereon, one or more of the first collection chamber and the second collection chamber. Each of the first collection chamber and the second collection chamber may include a pump system may include one or more pumps and oscillators configured to create positive pulsing pressure pulling input into the respective collection chamber, and to create negative pulsing pressure pushing output from a preceding fluid source. The water filtration method may further include providing ultraviolet radiation within one or more of the first collection chamber and the second collection chamber. The water filtration method may include aerating, by an aeration supply system arranged therein, one or more of the first collection chamber and the second collection chamber, the aeration supply system comprising a further porous pipe configured to receive an input of air and provide the air through pores of the further porous pipe into the respective collection chamber. The water filtration method may further comprise supplying one or more chemicals by a chemical supply system arranged in the respective collection chamber, the chemical supply system comprising a further porous pipe configured to receive an input of the one or more chemicals and provide the one or more chemicals through pores of the further porous pipe into the respective collection chamber. One or more of the first collection chamber and the second collection chamber may include an aeration and chemical supply system therein, the aeration and chemical supply system comprising a further porous pipe configured to receive an input of air and one or more chemicals and provide the air and the one or more chemicals through pores of the further porous pipe into the respective collection chamber. The water filtration method may further include a tertiary treatment process may include: processing one or more of the second filtered fluid, the third filtered fluid, or the fourth filtered fluid with one or more of an activated carbon filtration process, an ion exchange process, and a reverse osmosis process.

In the embodiments of the water filtration system and method described above, the porosity sizes may vary. The first porosity size may be 30,000 microns, or may be a size that ranges in between 10,000 and 30,000 microns, such as between 25,000 and 30,000 microns, between 20,000 and 30,000 microns, between 15,000 and 30,000 microns. The second porosity size may a size be between 1,000-10,000 microns, such as 1,000 microns, 2,000 microns, 3,000 microns, 4,000 microns, 5,000 microns, 6,000 microns, 7,000 microns, 8,000 microns, 9,000 microns, and 10,000 microns. The third porosity size may a size be between 250-1,000 microns, such as 250 microns, 300 microns, 400 microns, 500 microns, 600 microns, 700 microns, 750 microns, 800 microns, 900 microns, and 1,000 microns. The fourth porosity size may a size be between 1-250 microns, such as 1 micron, such as 1-10 microns, 25 microns, 50 micron, 100 microns, 200 microns, and 250 microns.

### BRIEF DESCRIPTION OF THE FIGURES

FIG. 1 shows a conventional wastewater treatment plant according to the prior art;

FIGS. 2A shows an intake single phase filtering using a porous pipe according to the present application;

FIG. 2B shows a discharge single phase filtering using a porous pipe according to the present application;

FIG. 3 shows an overview of particulate filtering using a porous pipe filtering system according to the present application;

FIG. 4 shows an overview of a modular processing flow using a porous pipe filtering system according to the present application;

FIG. 5 shows aspects of the porous pipe system of the present application using pulsing and vibration to deliver wastewater;

FIG. 6 shows aeration, heat, and chemical mixing of the porous pipe filtering system according to the present application;

FIG. 7 shows a power system for the porous pipe system according to the present application;

FIG. 8 shows a first phase porous pipe serial discharge module for filtering and processing very large wastewater sludge;

FIG. 9A shows an end view of concentric porous pipe filtration according to the present application;

FIG. 9B shows a further view of porous pipe concentric discharge filtering and processing according to the present application;

FIG. 10A shows a second phase porous pipe serial discharge module for filtering and processing of large sludge according to the present application;

FIG. 10B shows an intermediate phase porous pipe serial discharge module for filtering and processing medium sludge according to the present application;

FIG. 10C shows a final phase porous pipe serial discharge module for filtering and processing smallest sludge according to the present application;

FIG. 10D shows the combined phases for the serial discharge module layout according to the present application;

FIG. 11A shows a final sludge processing according to the present application in which sludge of different sizes are processed separately;

FIG. 11B shows a final sludge processing according to the present application in which combined sludge is processed;

FIG. 12 shows a first example system with wastewater pretreatment using the porous pipe system of the present application;

FIG. 13 shows a second example system with wastewater pretreatment using the porous pipe system of the present application;

FIG. 14 shows a third example system with wastewater pretreatment using the porous pipe system of the present application; and

FIG. 15 shows a fourth example system with wastewater pretreatment using the porous pipe system of the present application.

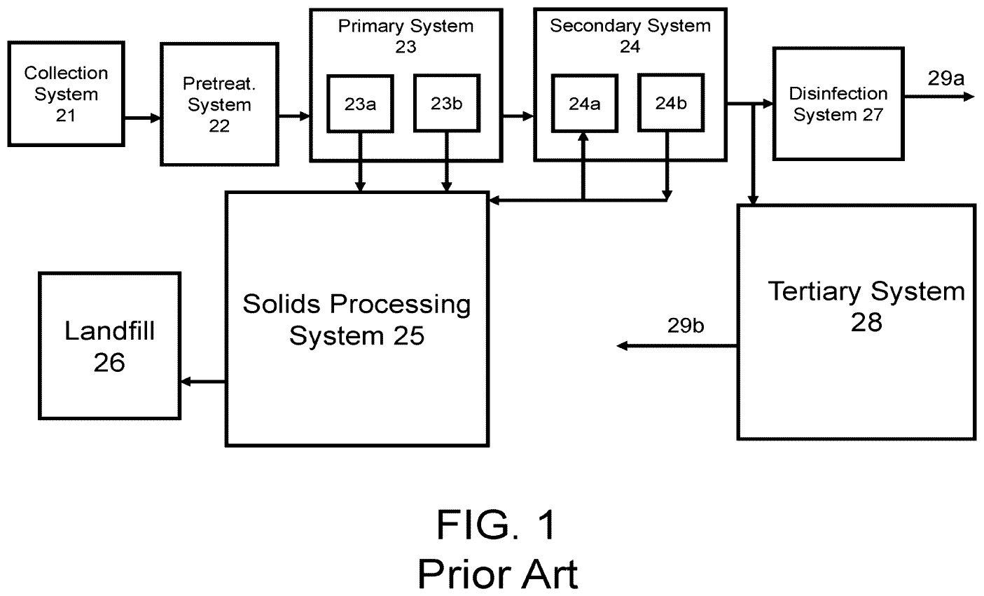

### DETAILED DESCRIPTION OF THE DRAWINGS

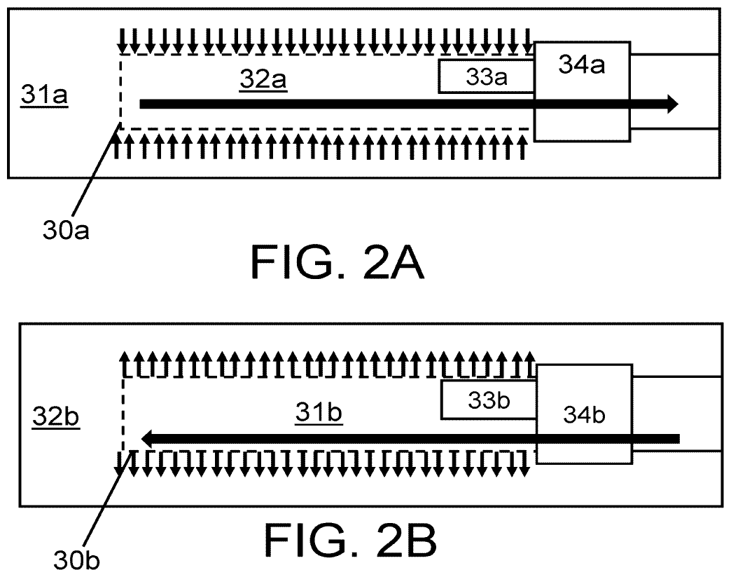

The porous pipe filtering and processing systems for wastewater treatment of the present application are described in further detail below with reference to FIGS. 2A-15.

FIGS. 2A and 2B show two ways to filter using a porous pipe: an intake single phase filtering using a porous pipe 30a (FIG. 2A) and a discharge single phase filtering using a porous pipe 30b (FIG. 2B). In FIG. 2A, a porous pipe 30a is provided in a fluid 31a, and the porous pipe 30a intakes the filtered fluid 32a. The pores of the porous pipe 30a filter the fluid 31a as it is taken into the porous pipe 30a. A vibration transducer 33a is provided to keep the pores of the porous pipe 30a clear, and an oscillating pump 34a is provided to pull the fluid 31a into the porous pipe 30a. In FIG. 2B, a porous pipe 30b is provided for discharging a fluid 31b, and the porous pipe 30b discharges a filtered and diffused fluid 32b. The pores of the porous pipe 30a filter the fluid 31b as it leaves the porous pipe 30a. A vibration transducer 33b is provided to keep the pores of the porous pipe 30b clear, and an oscillating pump 34b is provided to pull the fluid 31a into the porous pipe 30a. The porous pipes 30a, 30b can be installed at an angle to create a gravity feed. The porous pipes 30a, 30b can optionally be rotated, and the walls vibrated by vibration transducers 33a, 33b to reduce clogging, break up soft particulate and move the particulate to the discharge.

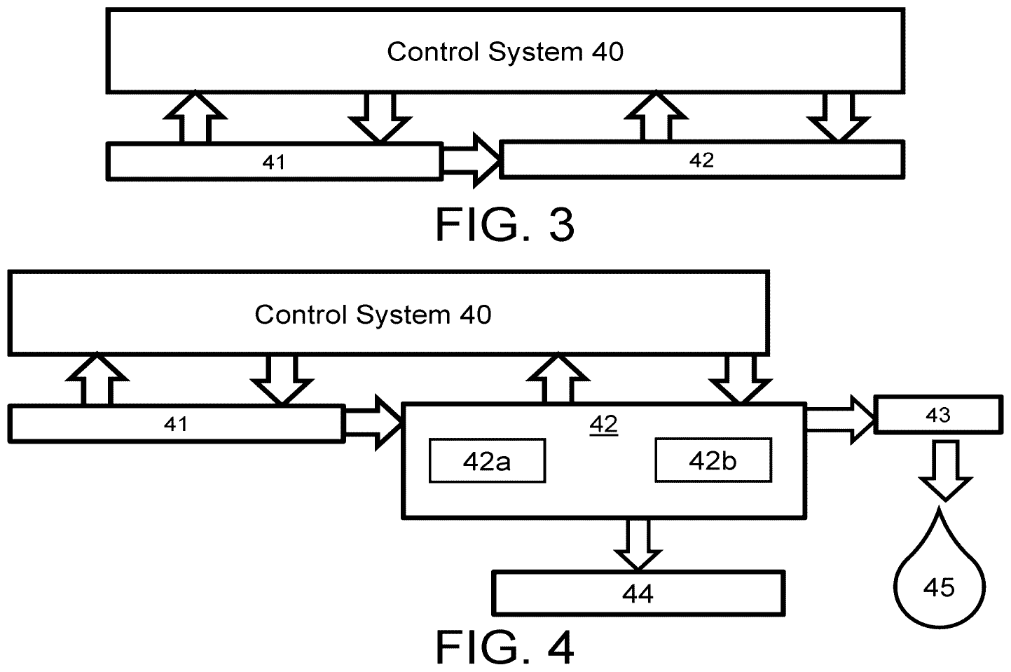

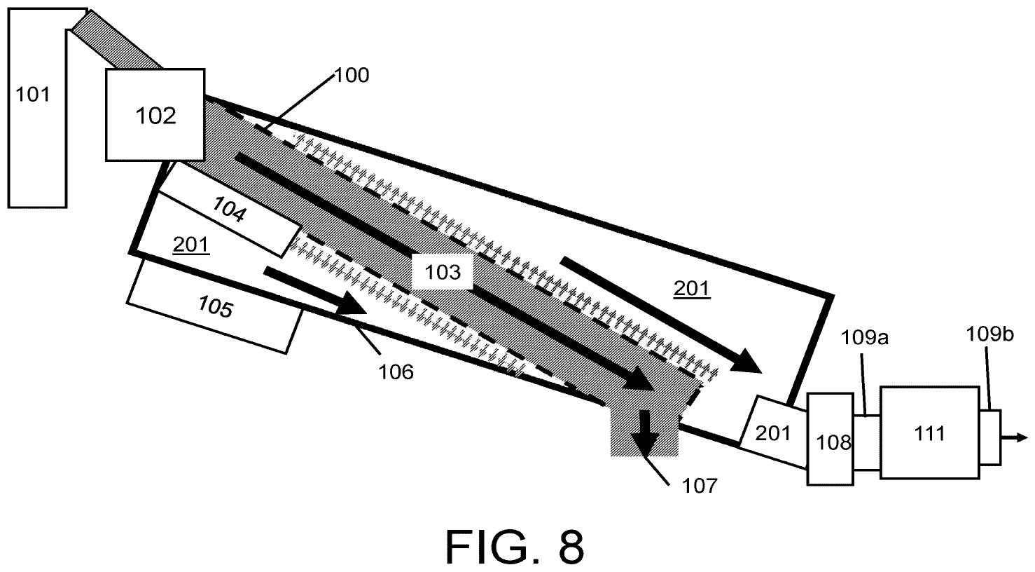

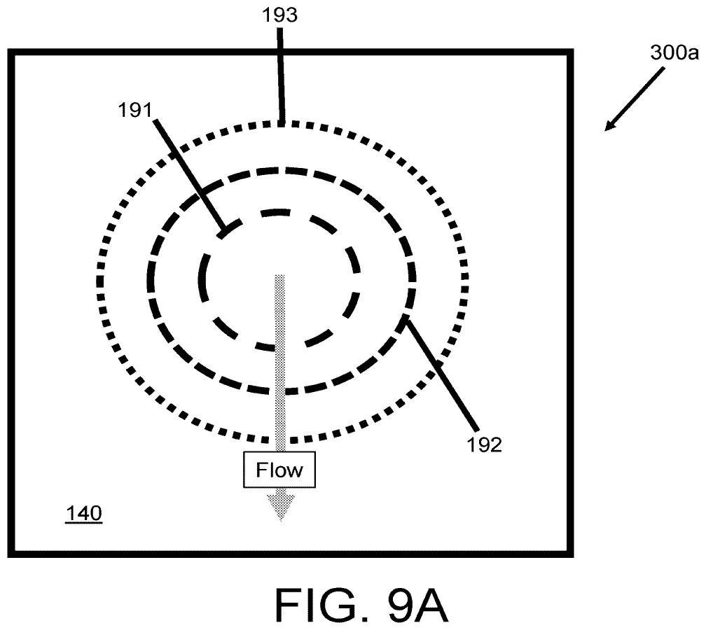

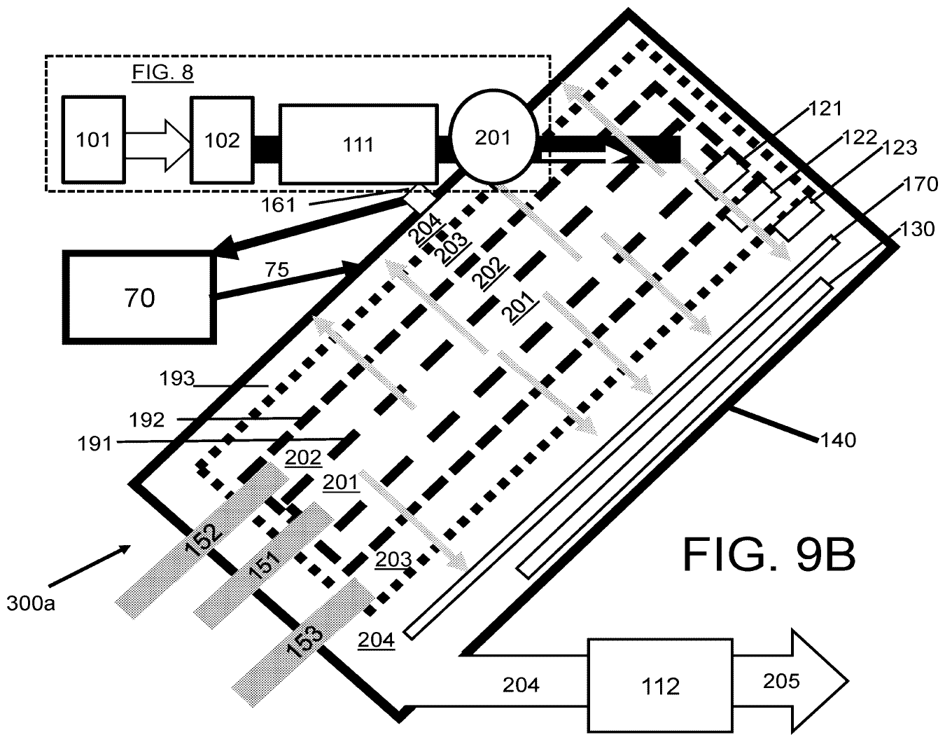

FIG. 3 shows an example of very large particulate filtering process using the porous pipe system described herein. This process can be organized in any number of flexible designs for filtering and processing, including the control system 40, concentric porous pipes, and serial porous pipes. The process includes a first phase 41 for very large particulate filtering through a porous pipe, which removes debris such as branches, bottles, cans, cardboard, toys, and other large particulates. Pulsing and vibrations in the porous pipe break-up large soft particulate. Optional aeration, heat, chemical and ultra-violet treatment can also be provided in the first phase 41. In the first phase 41, the flow path through the pores of porous pipe can be 30,000 microns diameter. An example of a first phase 41 is shown in greater detail in FIG. 8, which is described below. Additional processing phases 42 can also be provided as need, and multiple iterations of each phase can be implemented to address planned wastewater flows, including overflow conditions.

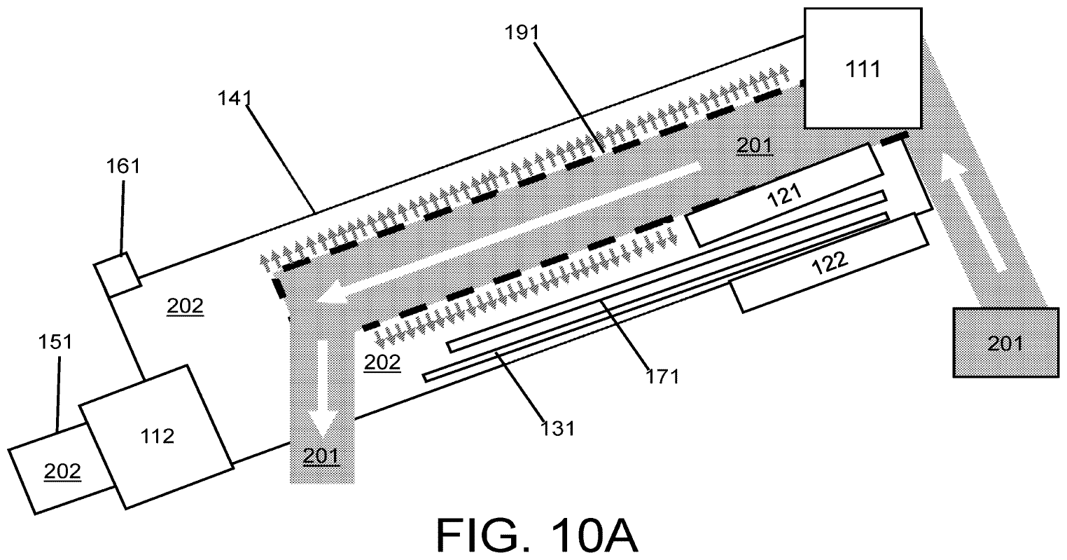

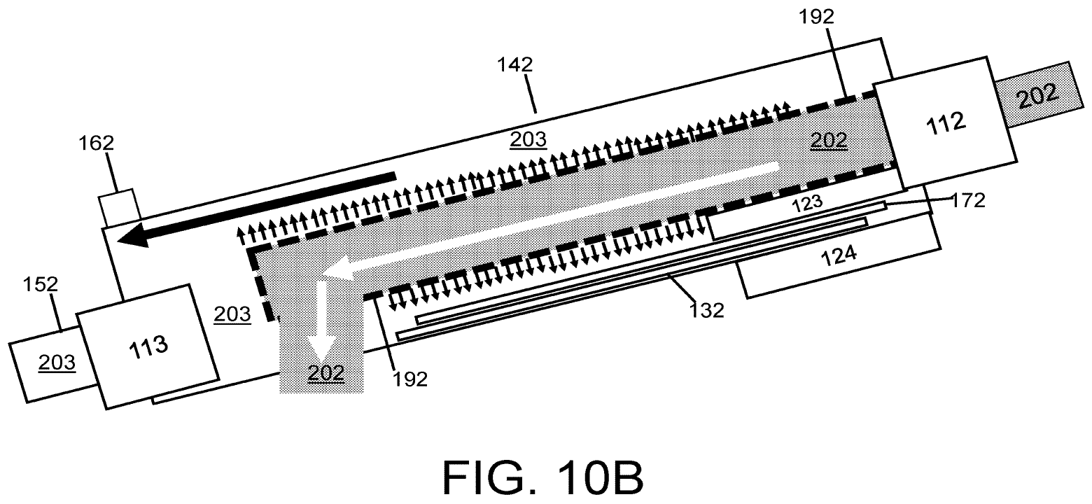

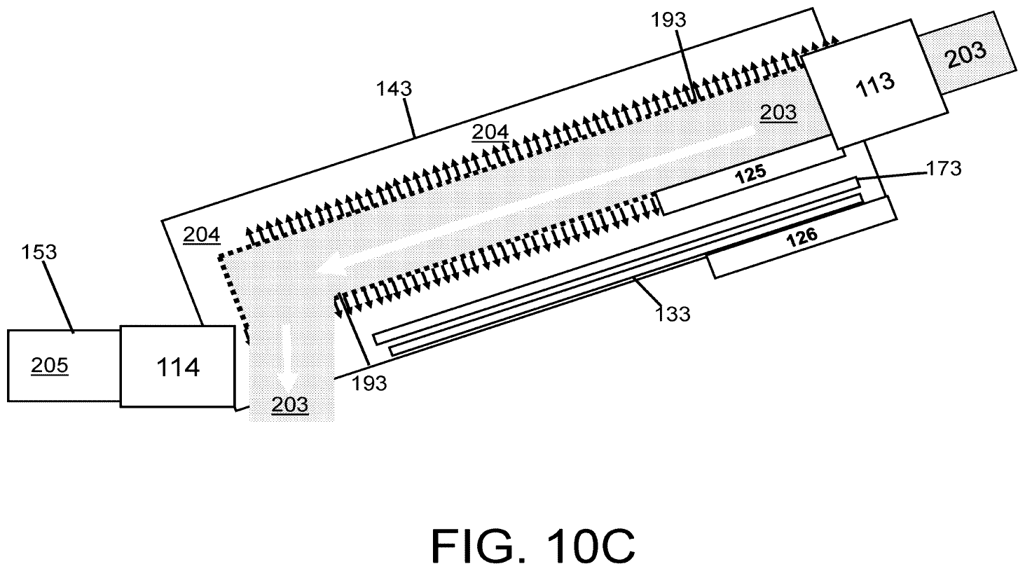

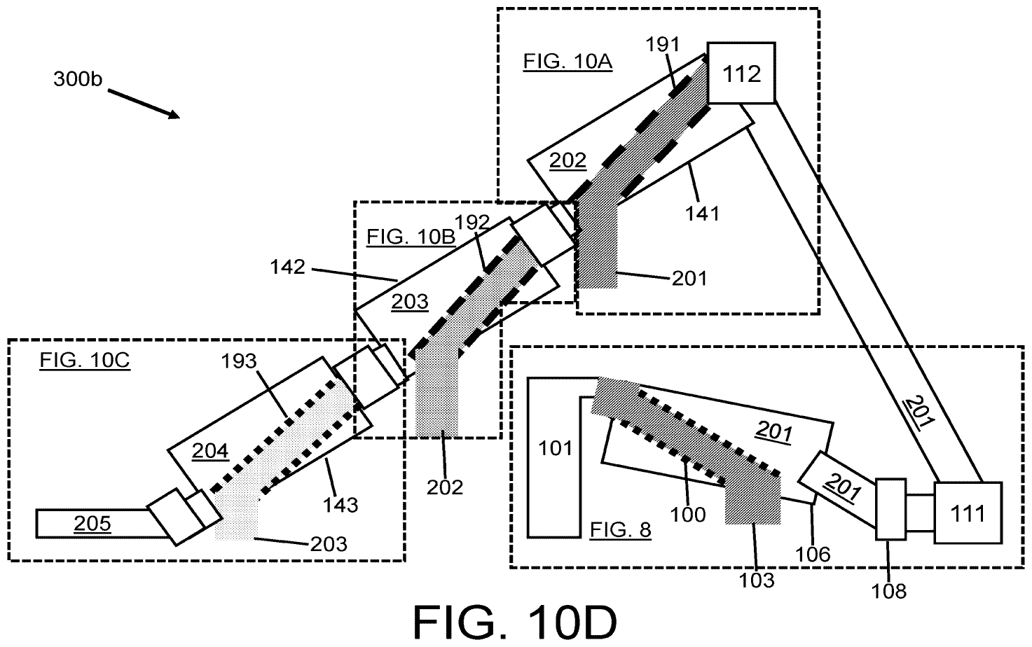

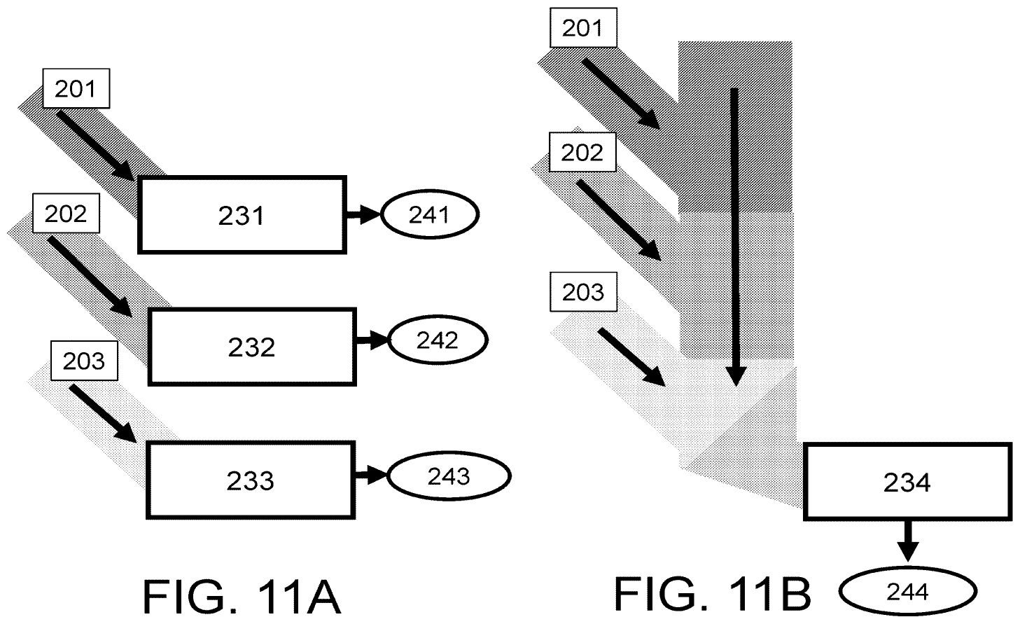

FIG. 4 shows an example of a modular processing flow using the porous pipe system. In the modular flow process, the same first phase 41 is provided for very large particulate filtering as noted above. The modular processing flow of FIG. 4 also includes additional phases 42, including a second processing phase 42a and a third processing phase 42b. The second processing phase 42a includes sludge filtering, which is shown and described in FIGS. 9A-9B and 10A-10D. A third processing phase 42b can be repeated to achieve more processing and particulate separation. Pulsing and vibrations in the porous pipe break-up large soft particulate. Optional aeration, heat, chemical and ultra-violet treatment can also be provided in the first phase 41. In the second and third phases 42a, 42b, the flow path through flow path through the pores of porous pipes can decrease progressively, such as from 10,000 microns, to 250 microns, to 50 microns. Sludge from the additional processing phases 42 can be provided for an optional sludge processing phase 44, examples of which are shown in FIGS. 11A and 11B and described in greater detail below. Processed water from the additional processing phases 42 can be provided to an optional, tertiary processing phase 43, as needed, which can perform carbon filtering, ion exchange, and/or reverse osmosis to provide reclaimed water 45.

The control system 40 may control several components of the porous pipe filtering system, including: pump systems 34a, 34b; vibration transducers 33a, 33b; an aeration and chemical supply system 60; a methane collection and release valve; an ultraviolet radiator; and a comminutor. The control system may comprise one or more transmitters and receivers transmitting and providing signaling, data, and instructions to and from the components of the porous pipe filtering system and to and from sensors in the porous pipe filtering system configured to monitor factors such as flow, temperature, pressure, and particulate size. The control system 40 may comprise a non-transitory computer readable medium or memory stored with instructions configured to implement the operations of the control system 40.

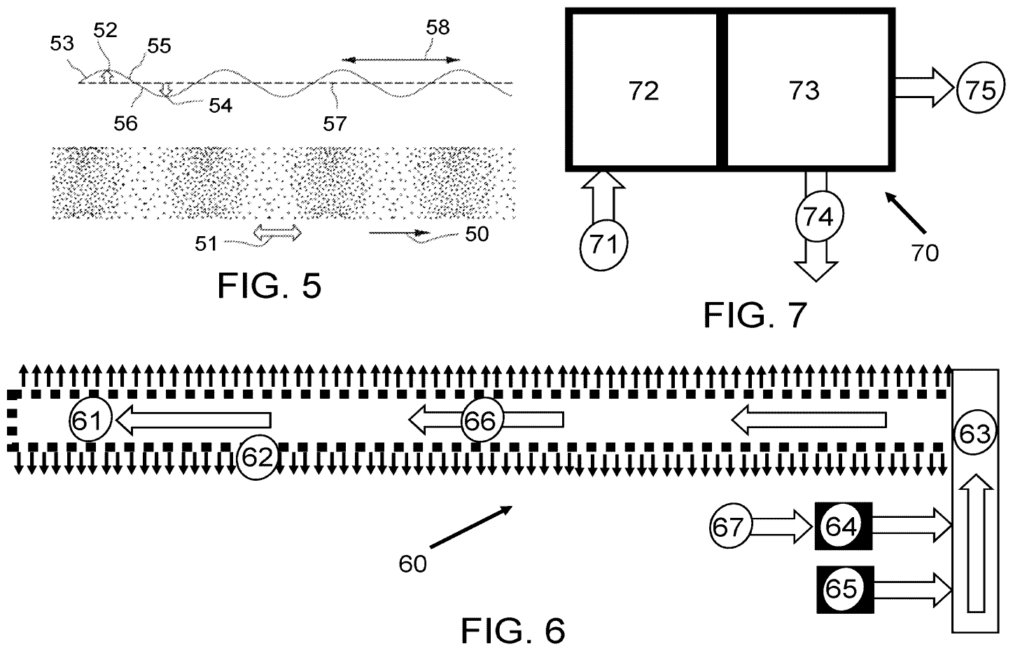

Each of the pump systems 34a, 34b may comprise pumps, oscillators, and flow measurement devices 34a, 34b which pump, pulse, and measure the wastewater flow through the porous pipes 30a, 30b. Pulses break down larger soft sludge and moves the particulate. The pressure and pulse frequencies are determined and controlled by the control system 40. The pump creates low pressure in its input and higher pressure in its output and the control system 40 regulates the pump pressure. The oscillators create the frequency and phases of the pulses, and the control system 40 controls the oscillators to synchronize the frequency and phases creating positive interference which doubles the amplitude of the pulses, as described below in reference to FIG. 5. Pulses break down larger soft sludge and moves the large particulate.

The control system 40 controls the amplitude, frequency, and phase of the vibration transducers 33a, 33b that create the vibrations in the porous pipes 30a, 30b and collection chamber. Vibrations break down larger soft sludge and moves the particulate. The vibrations used for each filtering step can be tuned to the size of the particulate.

The control system 40 also regulates the aeration and chemical supply system 60, which comprise aeration pumps for air or hot air supply and pumps for optional chemical treatment. The aeration and chemical supply system 60 uses a porous pipe 62, separate from the porous pipes performing the wastewater filtering, to break down the air into fine steams that facilitate the mixing of the air or hot air for aeration and chemical distribution. As the filtration levels increase the effluent flow becomes a spray which increase the surface contact between the effluent, the air, the heat and the chemicals. The increased surface contact makes the process more efficient. This process and system are shown in FIG. 6 and described further below.

The control system 40 balances the required power for the system, which comes from various sources such as the grid, solar arrays and a gas turbine, as shown in FIG. 7. The heat from the exhaust of the gas turbine is delivered through a heat exchanger and pump to the aerator shown in FIG. 6. The control system 40 also regulates an air and methane release valve. If there is enough methane can be routed to the electric gas turbine for the generation of electricity and heat, as shown in FIG. 7.

The control system 40 further is configured to regulate any ultraviolet radiating components. Ultraviolet (UV) treatment in the porous pipe system can be optionally provided. Disinfection is a primary mechanism for the inactivation or destruction of pathogenic organisms to prevent the spread of waterborne diseases to downstream users and the environment. It is important that wastewater be adequately treated prior to disinfection for any disinfectant to be effective. The effectiveness of a UV disinfection system depends on the characteristics of the wastewater, the intensity of UV radiation, the amount of time the microorganisms are exposed to the radiation, and the reactor configuration. For any one treatment plant, disinfection success is directly related to the concentration of colloidal and particulate constituents in the wastewater. The components of a UV disinfection system may include mercury arc lamps, a reactor, and ballasts. The source of UV radiation is either the low-pressure or medium-pressure mercury arc lamp with low or high intensities. UV has many advantages over other disinfection processes: UV is effective and quick; there is no need for holding tanks and reaction times; there is no need for storing chemicals; UV does not alter the taste of water, which makes it ideal for use in bottling plants and food processing applications; UV is safe; there is no need to add or handle hazardous chemicals or risk polluting the environment; UV is compatible with all other water treatment processes there is no need for de-chlorination if using reverse osmosis (RO) systems.

The comminutor grinds up the large sludge and particulate into smaller sizes. In various embodiments of the system, the porous pipe power system comminutor is the TASKMASTER® TITAN®, which is a unique, high-flow channel grinder with a full-cut design that offers protection for pumps, filter presses and other downstream equipment.

FIG. 5 diagrams aspects of the porous pipe system of the present application using pulsing and vibration to deliver wastewater. Pulsing and vibrations provide several advantages. Using vibration, the system effectively dislodges all particulate that does not flow through the porous pipe (prevents clogging) and breaks down large soft sludge. Like a vibratory parts feeder, the vibrations move the filtered particulate to the particulate discharge. The pulsing helps move the sludge and breaks down the soft sludge. The frequency of the pulses from the pushing pump is synchronized with the frequency pulses from the pulling pump creating constructive interference (resonance-doubles the amplitude). Multiple frequencies can be used simultaneously. FIG. 5 shows a longitudinal sound wave propagating in air and having a sinusoidal form with pressure peaks and troughs shown in relation to atmospheric pressure, also showing the wave of causing air particle displacement parallel to the direction of propagation, left to right in the Figure, with rarefactions and compressions of air molecules corresponding to the decreased pressure and increased pressure, respectively. A wave is a disturbance or variation that travels through a medium. The medium in the example of FIG. 5 is air through which the disturbance or sound or pressure wave travels. The pressure of a sinusoidal pressure wave is shown plotted versus time in FIG. 5 propagating 50 from left to right. If FIG. 5 were animated, the impression would be that the regions of compression travel from left to right. Although the air molecules experience some local oscillations as the pressure wave passes, the molecules do not travel with the wave. The forward motion pushes air molecules horizontally to the right to create a high-pressure area and the backward retraction of the tine to the left creates a low-pressure area allowing the air molecules to move back to the left. As shown in the plot of displacement in the bottom half of FIG. 5, because of the longitudinal motion 51 of the air molecules, there are regions where the air molecules are compressed together and other regions where the air molecules are spread apart. These regions are known as compressions and rarefactions, respectively. The compressions are regions of high air pressure, and the rarefactions are regions of low air pressure. At the far left, an increased pressure compression is depicted corresponding to a peak 52, following an up amplitude 53. A decreased pressure rarefaction corresponding to a trough 54 then follows down amplitudes 55 and 56. The maximum distance (the crest or trough) that a molecule of the air moves away from its rest position, indicated by horizontal line 57 in FIG. 5, is the amplitude. As such, this may be understood as the amplitude of the movement of an air molecule caused by the pressure wave as it propagates through the air. The sinusoid in FIG. 5 represents the extremes of the horizontal molecule displacement amplitude of the air molecules as the pressure wave moves. It may also be seen as representative of the pressure amplitude of the wave as it propagates through the air. The wavelength 58 of such a wave is the distance that the wave travels in the air in one complete wave cycle. The wavelength is commonly measured as the distance from one compression to the next adjacent compression or the distance from one rarefaction to the next adjacent rarefaction.

Wave interference is the phenomenon that occurs when two waves meet while traveling along the same medium. The interference of waves causes the medium to take on a shape that results from the net effect of the two individual waves upon the particles of the medium. With two pulses of the same amplitude traveling in different directions along the same medium, each pulse is displaced upward one unit at its crest and has the shape of a sine wave. As the sine waves move towards each other, there will eventually be a moment in time when the waves completely overlap. At that moment, the resulting shape of the medium would be an upward displaced sine pulse with amplitude of two units. When the two out of phase waves meet, the compression and rarefactions overlay and the resultant wave has zero compression and rarefaction, as the waves cancel each other with destructive interference. If two waves meet in-phase, the compression is additive and the rarefaction is additive.

With respect to pressure waves for the wastewater control system for the porous pipe system, in linear media, any wave pattern can be described in terms of the independent propagation of sinusoidal components. In a dispersive medium, the phase speed (magnitude of the phase velocity) depends upon the frequency of the wave, making the relationship between wavelength and frequency nonlinear. Depending on the length of the porous pipe the control system will regulate the pump pressure and the oscillating frequencies to achieve constructive interference in the flows. The optimum frequency will depend on the particulate size flowing through each porous pipe. The filtered flow exiting a porous pipe is equal to the flow into the porous pipe less the filtered particulate.

FIG. 6 shows aeration, heat, and chemical mixing into the porous pipe system, which is optional for each phase by an aeration and chemical supply system 60. The aeration and chemical supply system 60 comprises a pump 64 for air or hot air, and a pump 65 for chemicals. The main chemicals used in wastewater treatment are pH neutralizers, anti-foaming agents, coagulants, and flocculants. The chemicals used for mixing in the present application may include alum or aluminum sulfate, sodium aluminate, polyaluminum chloride, dewatering polymer, sodium hydroxide, ferric chloride, ferrous chloride, and others. The pumps 64, 65 can pump either or both of the air and chemicals into a flow pipe 63, which flow 66 into the porous pipe 61. The air and/or chemicals flow 66 through the porous pipe 61, and the air and/or chemicals are discharged 62 through the pores of the porous pipe 61 into the wastewater environment. A flow of blended hot air 67 from the power system 70 shown in FIG. 7 may also be supplied with the air pump 64.

FIG. 7 shows a power system 70 for the wastewater porous pipe filtering system of the present application. The electricity 75 for the porous pipe filtering system comes from methane generated solar, and an electric grid. In the power system 70 shown in FIG. 7, a solar panel array 71 may provide electricity to a grid 72, which may also receive and provide electricity from traditional methods. One or gas turbines 73 generate electricity using generated methane and natural gas. The exhaust 74 from the turbines 73 can be provided to a heat exchanger for heating, and provided for input as hot air by the pump 64 described above. The combined electricity 75 from the sources utilized is then provided for use by the wastewater system.

FIG. 8 shows a first phase porous pipe serial discharge module for filtering and processing very large wastewater sludge in a primary treatment stage. In the first phase porous pipe 100, the pores of the pipe may be approximately 30,000 microns in diameter to allow flow paths of 30,000 microns, wherein particulate greater than 30,000 microns do not pass through the pores of the porous pipe 100.

A wastewater source 101, which may be any residential, commercial, industrial or municipal water source provides the wastewater with contaminants to a pump system 102. The pump system 102 comprises pumps, oscillators and flow measurement devices as previously described. The pump system 102 pumps, pulses, and measures the wastewater flow. Pulses break down larger soft sludge and move the large particulate. The pressure and pulse frequencies are determined and controlled by the control system 40 (not shown). A flow 103 of very large particulate and sludge passes through the porous pipe 100. The pump and oscillator of the pump system 102 create positive pulsing pressure and the pump and oscillator of a pump system 111 at the opposite end of the porous pipe 100 create negative pulsing pressure, which combine to create constructive enhancing flow, as previously described with respect to FIG. 5. The porous pipe 100 is arranged within a collection chamber 106, which receives the large particulate sludge 201 that exits the pores of the porous pipe 100. The porous pipe 100 and collection chamber 106 may be arranged on a downslope relative to the flow direction. The porous pipe 100 is provided with at least one vibration transducer 104 to vibrate the porous pipe and the collection chamber is also provided with a vibration transducer 105 to vibrate the collection chamber 106. The largest particulate 103 can be provided out of a terminating end 107 of the porous pipe 100 for grinding, processing and/or disposal. A comminutor 108 may further be provided at an outlet of the collection chamber 106 to grind large particulate sludge 201 into smaller sizes, to provide a ground particulate and sludge discharge 109a to the pump system 111, for providing filtered and ground particulate and sludge 109b for further processing in additional treatment stages of the porous pipe treatment system, described below and shown in FIGS. 9A-10D. In further embodiments, the comminutor 108 can be omitted.

Following the first phase wastewater treatment of FIG. 8 to remove very large particulates, the output of sludge and water still comprises particulates requiring further treatment phases. In accordance with the present application, these processing phases can be performed using either a system 300a of concentrically arranged porous pipes having decreasing sizes of porosity (FIGS. 9A-9B), or a system 300b of serial discharge modules comprising porous pipes having sequentially smaller porosity (FIGS. 10A-10D).

FIGS. 9A and 9B show a system 300a for second and subsequent phases of filtering and processing wastewater with concentric porous pipe filtration in a secondary treatment stage. FIG. 9B shows second through fourth phase porous pipe concentric discharge filtering and processing. In the system 300a, second, third, and fourth filtering and processing phases are provided with porous pipes 191, 192, 193 (respectively). However, in other embodiments, fewer or more processing phases can be provided. The treatment system 300a follows the system of FIG. 8 and may receive as the initial input large particulate sludge 201 that has been processed by the porous pipe 100 system of FIG. 8 as described above. It is understood that the large particulate sludge 201 may correspond to the ground particulate and sludge discharge 109a, filtered and ground particulate and sludge 109b, or the large particulate sludge 201 from the collection chamber 106 processed without comminutor 108. In FIGS. 9A and 9B, the fluid flow from the porous pipes 191, 192, 193 into a collection chamber 140 are illustrated with gray arrows.

A first, innermost porous pipe 191 is provided receiving the large particulate sludge 201 as a second treatment phase. The porous pipe 191 comprises pores smaller than the pores of the porous pipe 100, for example, between 1,000-10,000 microns to allow fluid flow paths of 1,000-10,000 microns out of the porous pipe 191, wherein particulate over this size do not pass through the pores of the porous pipe 191, but are provided to a discharge 151 for further processing. The porous pipe 191 is also provided with a vibration transducer 121.

A second porous pipe 192 is provided around the innermost porous pipe 191 and receives a medium particulate sludge 202 that passes through the pores of the porous pipe 191 as a third treatment phase. The porous pipe 192 comprises pores smaller than the pores of the porous pipe 191, for example, between 250-1,000 microns to allow fluid flow paths of 250-1,000 microns out of the porous pipe 192, wherein particulate over this size do not pass through the pores of the porous pipe 192, but are provided to a discharge 152 for further processing. The porous pipe 192 is also provided with a vibration transducer 122.

A third porous pipe 193 is provided around the second porous pipe 192 and receives a smaller particulate sludge 203 that passes through the pores of the porous pipe 192 as a fourth treatment phase. The porous pipe 193 comprises pores smaller than the pores of the porous pipe 192, for example, between 50-250 microns to allow fluid flow paths of 50-250 microns out of the porous pipe 193, wherein particulate over this size do not pass through the pores of the porous pipe 193, but are provided to a discharge 153 for further processing. The porous pipe 193 is also provided with a vibration transducer 123.

The smallest particulate sludge 204 passes through the porous pipe 193 into the collection chamber 140. The collection chamber 140 may comprise an ultraviolet radiator 170 and an aeration and chemical supply system 130, as previously described above and shown in FIG. 6, which are configured to treat the sludge 204. A power system as previously described above and shown in FIG. 7 supplies electricity to the system 300a. The system 300a may also comprise a methane collection valve 161 configured to collect methane from the sludge 204 and provide the methane to the power system 70.

The system 300a further comprises a pump system 112. The pump and oscillator of the pump system 111 creates positive pulsing pressure and the pump and oscillator of a pump system 112 at the opposite end of the system 300a creates negative pulsing pressure, which combine to create constructive enhancing flow, as previously described with respect to FIG. 5. The final sludge 204 may be pumped out of the collection chamber 140 by the pump system 112 and the reclaimed water 205 output from the system 300a. The reclaimed water 205 may be subjected to further tertiary treatment steps mentioned above and described further below.

Alternatively to the concentric porous pipe system 300a of FIGS. 9A-9B, the second and subsequent phases of treatment can be performed by a system 300b of serial discharge modules comprising porous pipes having sequentially smaller porosity. FIG. 10D shows the system 300b, and FIGS. 10A-10C show the discharge modules that are combined in FIG. 10D.

FIG. 10A shows a diagram of a second phase porous pipe serial discharge module for filtering and processing of large sludge 201. The treatment module of FIG. 10A follows the system of FIG. 8 and may receive as the initial input large particulate sludge 201 that has been processed by the porous pipe 100 system of FIG. 8 as described above. It is understood that the large particulate sludge 201 may correspond to the ground particulate and sludge discharge 109a, filtered and ground particulate and sludge 109b, or the large particulate sludge 201 from the collection chamber 106 processed without comminutor 108.

The discharge module of FIG. 10A comprises a porous pipe 191 receiving the large particulate sludge 201. The porous pipe 191 comprises pores smaller than the pores of the porous pipe 100, for example, between 1,000-10,000 microns to allow fluid flow paths of 1,000-10,000 microns out of the porous pipe 191, wherein particulate over this size do not pass through the pores of the porous pipe 191, but are discharged for further processing. The medium particulate sludge 202 passes through the porous pipe 191 into a collection chamber 141. The porous pipe 191 is provided with a vibration transducer 121 and the collection chamber 141 is provided with a vibration transducer 122. The collection chamber 141 may further comprise an ultraviolet radiator 171 and an aeration and chemical supply system 131, as previously described above and shown in FIG. 6, which are configured to treat the sludge 202. A power system (not shown) as previously described above and shown in FIG. 7 supplies electricity to module and the collection chamber 141 may also comprise a methane collection valve 161 configured to collect methane from the sludge 202 and provide the methane to the power system. The module further comprises a pump system 112. The pump and oscillator of the pump system 111 creates positive pulsing pressure and the pump and oscillator of a pump system 112 at the opposite end of the module creates negative pulsing pressure, which combine to create constructive enhancing flow, as previously described with respect to FIG. 5. The medium particulate sludge 202 may be pumped out of the collection chamber 141 by the pump system 112 through a discharge 151 and provided for further processing at the next module, as needed.

FIG. 10B shows a diagram of a third phase porous pipe serial discharge module for filtering and processing of medium particulate sludge 202 from the treatment module of FIG. 10A. The discharge module of FIG. 10B comprises a porous pipe 192 receiving the medium particulate sludge 202. The porous pipe 192 comprises pores smaller than the pores of the porous pipe 191, for example, between 250-1,000 microns to allow fluid flow paths of 250-1,000 microns out of the porous pipe 192, wherein particulate over this size do not pass through the pores of the porous pipe 192, but are discharged for further processing. The small particulate sludge 203 passes through the porous pipe 192 into a collection chamber 142. The porous pipe 192 is provided with a vibration transducer 123 and the collection chamber 142 is provided with a vibration transducer 124. The collection chamber 142 may further comprise an ultraviolet radiator 172 and an aeration and chemical supply system 132, as previously described above and shown in FIG. 6, which are configured to treat the sludge 204. A power system (not shown) as previously described above and shown in FIG. 7 supplies electricity to module and the collection chamber 142 may also comprise a methane collection valve 162 configured to collect methane from the small particulate sludge 203 and provide the methane to the power system. The module further comprises a pump system 113. The pump and oscillator of the pump system 112 creates positive pulsing pressure and the pump and oscillator of a pump system 113 at the opposite end of the module creates negative pulsing pressure, which combine to create constructive enhancing flow, as previously described with respect to FIG. 5. The small particulate sludge 203 may be pumped out of the collection chamber 142 by the pump system 113 through a discharge 152 and provided for further processing at the next module, as needed.

FIG. 10C shows a diagram of a fourth phase porous pipe serial discharge module for filtering and processing of small particulate sludge 203 from the treatment module of FIG. 10B. The discharge module of FIG. 10C comprises a porous pipe 193 receiving the small particulate sludge 203. The porous pipe 193 comprises pores smaller than the pores of the porous pipe 192, for example, between 50-250 microns to allow fluid flow paths of 50-250 microns out of the porous pipe 193, wherein particulate over this size do not pass through the pores of the porous pipe 193, but are discharged for further processing. The smallest particulate sludge 204 passes through the porous pipe 193 into a collection chamber 143. The porous pipe 193 is provided with a vibration transducer 125 and the collection chamber 143 is provided with a vibration transducer 126. The collection chamber 143 may further comprise an ultraviolet radiator 173 and an aeration and chemical supply system 133, as previously described above and shown in FIG. 6, which are configured to treat the sludge 204. A power system (not shown) as previously described above and shown in FIG. 7 supplies electricity to module. The module further comprises a pump system 114. The pump and oscillator of the pump system 113 creates positive pulsing pressure and the pump and oscillator of a pump system 114 at the opposite end of the module creates negative pulsing pressure, which combine to create constructive enhancing flow, as previously described with respect to FIG. 5. The smallest particulate sludge 204 may be pumped out of the collection chamber 143 by the pump system 114 through a discharge 153 providing the final reclaimed water 205, which can be provided for further tertiary treatment, as needed, or provided to a further discharge module.

FIG. 10D shows the combined phases for the serial discharge module layout, combining the modules of FIGS. 8, 10A, 10B, and 10C. A downward slope of the phases is maintained so the phases can be installed in different patterns. Alternative number of modules can be provided than those shown in FIG. 10D, and the individual modules can be installed as needed, with porous pipes having varying porosities. It is further noted that elements of the modules, such as the methane collection valves, vibration transducers, aeration and chemical supply systems, and ultraviolet radiators can be added or removed from the modules as needed, and the constructions of the modules and components therein are not limited to those shown in FIGS. 8 and 10A-10D.

In the various systems 300a, 300b described above, the sludge that is filtered by the porous pipes 191, 192, 193 is discharged for further processing. FIGS. 11A and 11B show two options for final sludge processing. In the sludge processing system of FIG. 11A, sludge sizes are processed separately. Large particulate sludge 201 is provided to a large particulate sludge digester 231 for processing, and to a large particulate disposal 241. Medium particulate sludge 202 is provided to a medium particulate sludge digester 232 for processing, and to a medium particulate disposal 242. Small particulate sludge 203 is provided to a small particulate sludge digester 233 for processing, and to a large particulate disposal 243. In the sludge processing system of FIG. 11b, the sludges 201, 202, 203 of different sizes are combined and provided to a combined particulate sludge digester 234 and combined particulate disposal 244.

The following optional processing can be added as additional tertiary processing to the porous pipe system: activated carbon filtering, sand filtering, stabilization ponds, biodisc system, ion exchange, reverse osmosis, and nano-bubbles.

In activated carbon filtering, the process of adsorption consists of the capture of soluble substances on the surface of a solid. A parameter for activated carbon filtering is the specific surface of the solid, as the target soluble compound to be eliminated must be concentrated on the surface. Activated carbon filtering is considered to be a refining treatment, and is applied at the end of common treatment systems, especially after a biological treatment. Factors that affect adsorption include solubility (i.e., less solubility leads to better adsorption), molecular structure (i.e., more branched leads to better adsorption), molecular weight (i.e., larger molecules lead to better adsorption), problems of internal diffusion can alter the standard, polarity (i.e., less polarity leads to better adsorption), and the degree of saturation (i.e., less saturation leads to better adsorption). The solid that is used in this process is activated carbon, although in recent years, various solid materials have been developed that improve the properties of activated carbon in certain applications. The economic viability of this process depends on the existence of an efficient means of regeneration of the solid once its capacity for adsorption is finished. The properties of the activated carbon deteriorate which is why it is necessary to replenish part of it with new carbon in each cycle. Alternatives to activated carbon are zeolites and clays (montmorillonite, sepiolite, bentonite, etc.), and recently, derivatives of polysaccharides have been developed. Activated carbon filtering devices and systems are known in the art.

Tertiary wastewater processing can be provided with and without reverse osmosis. An additional ion exchange option may also be provided to support reverse osmosis. Ion exchange processes and devices are known in the art, and remove or replace ions in the water.

Tertiary treatment of sewage water without reverse osmosis includes processes like filtration, lagooning, nutrient removal, and disinfection, which are discussed below: In the filtration process, either sand, charcoal or activated carbon are used to filter the wastewater. Tertiary treatment, or effluent polishing, is carried out to improve water quality. Most wastewater plants use at last one tertiary water treatment process, and some use two or more to decontaminate wastewater. Filtration is a common method of tertiary treatment, with either sand or activated carbon used to filter wastewater. The water is passed through a filter media, such as a bed of sand and/or charcoal, allowing particulate matter in the water to adhere to the filter medium, removing it from the water. The filtered water is then provided for disposal, and a backwash tank may also be provided to wash the filtering tank after treatment, and the backwash water provided back for primary treatment. Lagooning is a method in which water is stored for some time in man-made ponds where plants and invertebrate animals in the water ingest remaining particulate matter.

A further tertiary wastewater processing option is reverse osmosis. Reverse osmosis systems can be used combined with other water filtration units. Reverse osmosis removes impurities from contaminated water by applying pressure and forcing the contaminated water through membranes. After the water is treated it can be reused in production or can be disposed of safely. Reverse osmosis is a widely accepted unit operation for water purification, and methods and systems for reverse osmosis are known in the art. The water is typically pressured between 150 to 600 psi and passes through membranes, such as a thin film composite or cellulose acetate membranes. Reverse osmosis water recoveries of 70-90% are typical and salt rejection rates are between 90-99%. A factor in treating industrial wastewater with reverse osmosis is the pretreatment that protects the membrane against organic fouling, mineral scaling and chemical degradation. Before reverse osmosis should be considered, a complete cation/anion balance can be required and potential foulants must be identified. High Biological Oxygen Demand (“BOD”) and Chemical Oxygen Demand (“COD”) levels can also contribute to membrane fouling. The porous pipe system of the present application prepares the effluent for reverse osmosis.

The porous pipe modular wastewater treatment system described herein is flexible and can address many different wastewater problems. Depending on the application the system and the optional add-ons (depending on required potability) can help to solve wastewater issues with financially competitive and viable solutions. Inputs to the porous pipe modular system design include flow volume, nature of the particulates, nature of the sludge, potability required (some applications can use non-potable water that recycles into their process), chemicals required, levels of particulate separation required, UV required, aeration required, heat required, and cost of electricity.

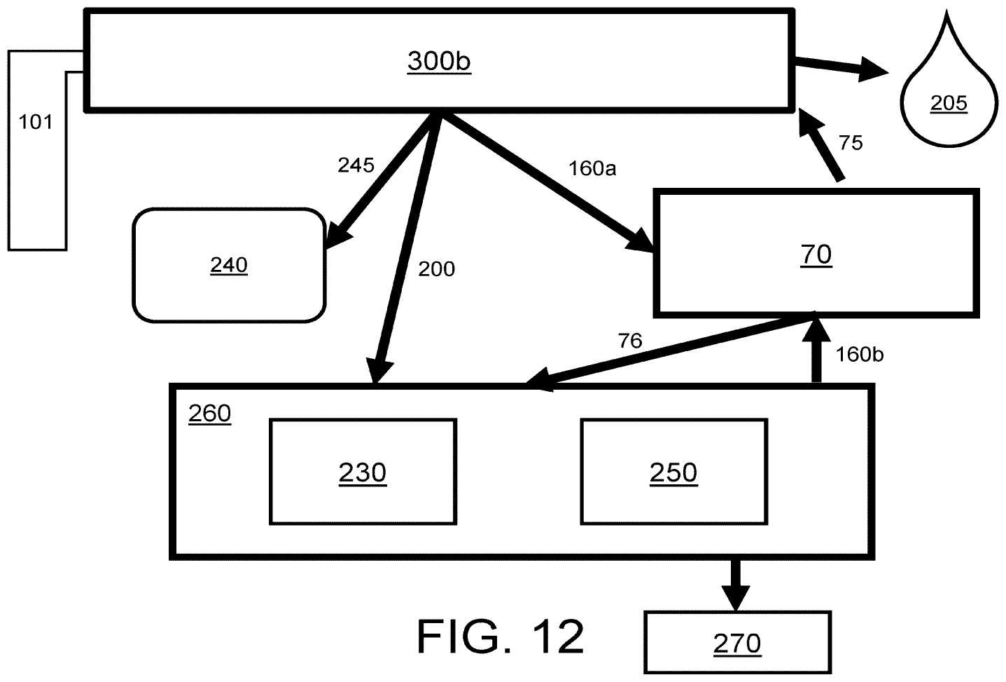

FIG. 12 shows a first example system with wastewater pretreatment using the porous pipe filtering system of the present application. A wastewater source 101 provides wastewater for treatment by a wastewater treatment system 300b as described above and shown in FIG. 10D, comprising the treatment modules of FIGS. 8 and 10A-10C. The concentric porous pipe system 300a may alternatively be used for the wastewater treatment. The wastewater treatment system 300b outputs reclaimed water 205, as described above. The power system 70 provides electricity 75 to the wastewater treatment system 300b and the wastewater treatment system 300b may supply methane 160a to the power system 70.

The wastewater treatment system 300b provides filtered out larger particulates 245 to a particulate disposal 240. The wastewater treatment system 300b also provides sludge 200 that has been filtered through the porous pipes to a sludge processing system 260. The sludge processing system 260 comprises a sludge digester 230, which digests the sludge as previously described, and provides it to a drying system 250 comprising a dryer to dry the digested sludge and a dry sludge finisher to process the dried sludge, which provides the final processed sludge to crops 270 for crop growth. Methane 160b recovered from the sludge processing system 260 can be provided to the power system 70, which also provides electricity 76 to the sludge processing system 260.

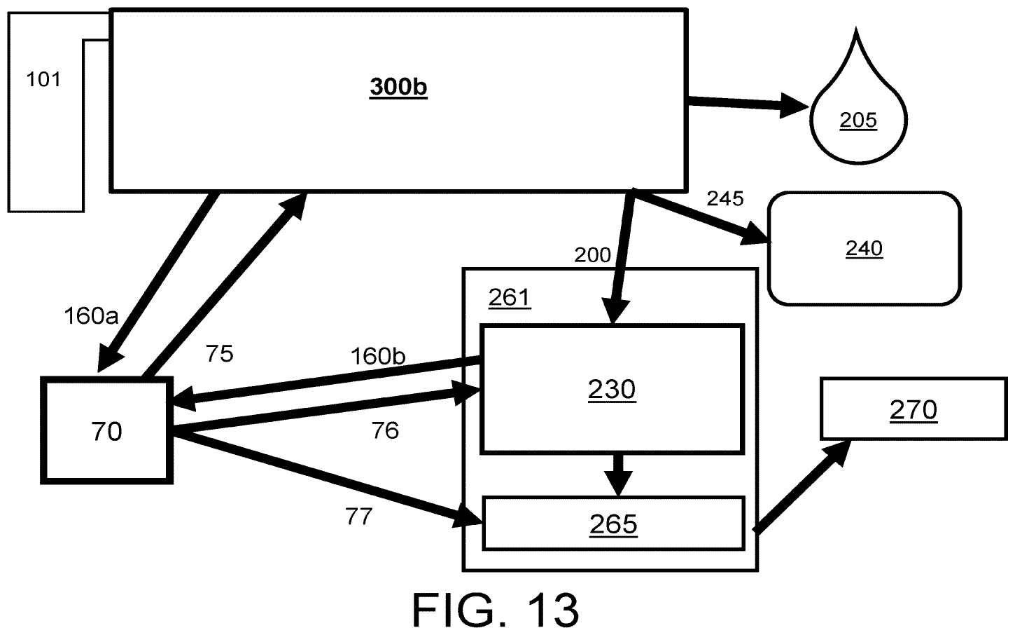

FIG. 13 shows a second example system with wastewater pretreatment using the porous pipe filtering system of the present application. A wastewater source 101 provides wastewater for treatment by a wastewater treatment system 300b as described above and shown in FIG. 10D, comprising the treatment modules of FIGS. 8 and 10A-10C. The concentric porous pipe system 300a may alternatively be used for the wastewater treatment. The wastewater treatment system 300b outputs reclaimed water 205, as described above. The power system 70 provides electricity 75 to the wastewater treatment system 300b and the wastewater treatment system 300b may supply methane 160a to the power system 70.

The wastewater treatment system 300b provides filtered out larger particulates 245 to a particulate disposal 240. The wastewater treatment system 300b also provides sludge 200 that has been filtered through the porous pipes to a sludge processing system 261. The sludge processing system 261 comprises a sludge digester 230, which digests the sludge as previously described, and provides it to one or more belt presses 265 configured to press out liquid remaining in the digested sludge, and final processed and dried sludge is provided to crops 270 for crop growth. Methane 160b recovered from the sludge processing system 261 can be provided to the power system 70, which also provides electricity 76, 77 to the sludge digester 230 and the belt presses 265.

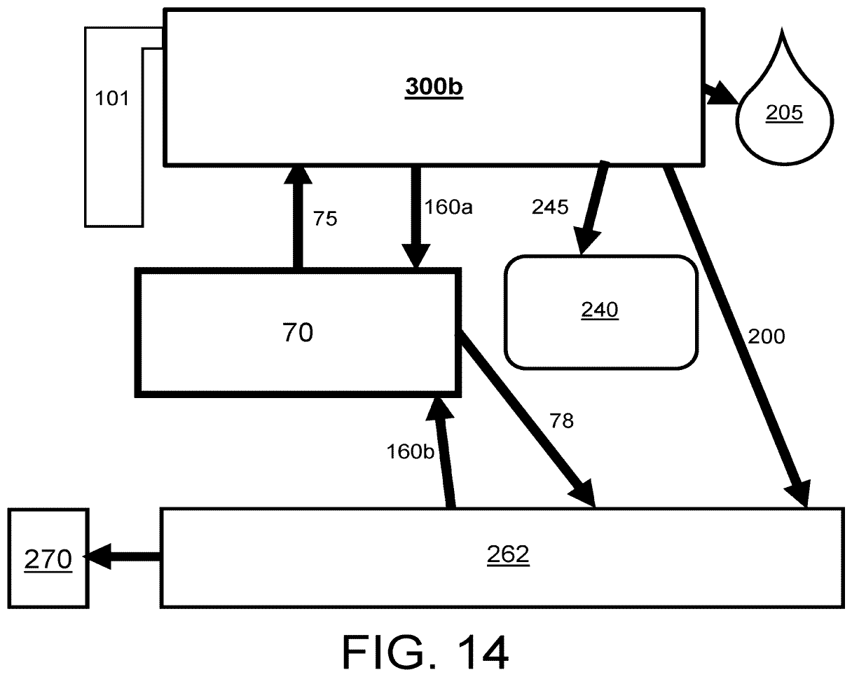

FIG. 14 shows a third example system with wastewater pretreatment using the porous pipe filtering system of the present application. A wastewater source 101 provides wastewater for treatment by a wastewater treatment system 300b as described above and shown in FIG. 10D, comprising the treatment modules of FIGS. 8 and 10A-10C. The concentric porous pipe system 300a may alternatively be used for the wastewater treatment. The wastewater treatment system 300b outputs reclaimed water 205, as described above. The power system 70 provides electricity 75 to the wastewater treatment system 300b and the wastewater treatment system 300b may supply methane 160a to the power system 70.

The wastewater treatment system 300b provides filtered out larger particulates 245 to a particulate disposal 240. The wastewater treatment system 300b also provides sludge 200 that has been filtered through the porous pipes to a sludge processing system 262. The sludge processing system 262 may comprise one or more of a sludge holding tank, one or more sludge digesters, and a drying mechanism such as dryers, belt presses, or screw presses. The sludge processing system 262 outputs the dried digested sludge to crops 270 for crop growth. Methane 160b recovered from the sludge processing system 262 can be provided to the power system 70, which also provides electricity 78 to the sludge processing system 262 and the belt presses 265.

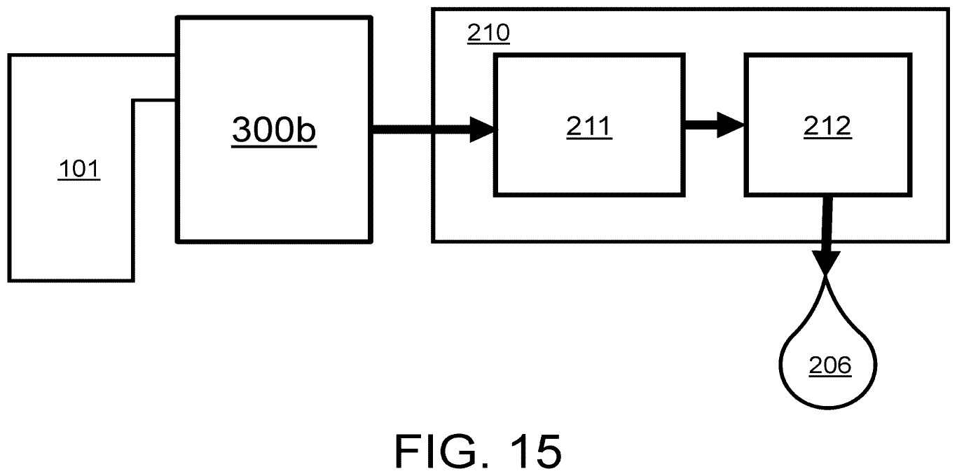

FIG. 15 shows a fourth example system with wastewater pretreatment using the porous pipe filtering system of the present application. In the system shown in FIG. 15, one or more tertiary treatments are performed. A wastewater source 101 provides wastewater for treatment by a wastewater treatment system 300b as described above and shown in FIG. 10D, comprising the treatment modules of FIGS. 8 and 10A-10C. The concentric porous pipe system 300a may alternatively be used for the wastewater treatment. The wastewater treatment system 300b outputs reclaimed water 205, as described above. The water 205 is provided to a tertiary treatment system 210. In the embodiment of FIG. 15, the tertiary treatment system 210 comprises an activated carbon filtering system 211 and a reverse osmosis system 212. The tertiary treatment system 210 may comprise additional or alternative tertiary treatment devices or systems, such as the filtering and/or ion exchange systems described previously. The tertiary treatment system outputs further treated water 206.

Relative terms used in the description of the porous pipe filtering system of the present application to indicate the size of particulate, such as “very large”, “large”, “medium”, “small”, or “smallest”, are not intended to imply a particular meaning or size and are used for the purpose of identifying the relative sizes of the particulates as they are filtered through the system.

It should be understood that, unless stated otherwise herein, any of the features, characteristics, alternatives or modifications described regarding a particular embodiment herein may also be applied, used, or incorporated with any other embodiment described herein. Also, the Figures herein are not drawn to scale. Although the invention has been described and illustrated with respect to exemplary embodiments thereof, the foregoing and various other additions and omissions may be made therein and thereto without departing from the spirit and scope of the present invention.

What is claimed:

1. A water filtration system comprising:
a first treatment system comprising:
a first collection chamber; and
a first porous pipe, arranged in the first collection chamber, comprising pores of a first porosity size and configured to receive a water input comprising water and particulate matter;
wherein the water input is configured to flow through the pores of the first porous pipe and provide a first filtered sludge into the first collection chamber while the pores of the first porous pipe block a first portion of the particulate matter comprising solid particulates greater in size than the first porosity size from passing into the first collection chamber; and
a second treatment system comprising:
a second collection chamber; and
a second porous pipe, arranged in the second collection chamber, comprising pores of a second porosity size and configured to receive the first filtered sludge from the first treatment system, wherein the second porosity size is smaller than the first porosity size;
wherein the first filtered sludge is configured to flow through the pores of the second porous pipe and to provide a second filtered fluid while the pores of the second porous pipe block a second portion of the particulate matter comprising solid particulates greater in size than the second porosity size from passing through the second porous pipe.

2. The water filtration system of claim 1, wherein the second filtered fluid is a second filtered sludge, and the second filtered sludge passes into the second collection chamber.

3. The water filtration system of claim 2, wherein the second treatment system further comprises:
a third collection chamber; and
a third porous pipe arranged in the third collection chamber and comprising pores of a third porosity size and configured to receive the second filtered sludge from the second collection chamber, wherein the third porosity size is smaller than the second porosity size;
wherein the second filtered sludge is configured to flow through the pores of the third porous pipe and to provide a third filtered fluid while the pores of the third porous pipe block a third portion of the particulate matter comprising solid particulates greater in size than the third porosity size from passing through the third porous pipe.

4. The water filtration system of claim 3, wherein the third filtered fluid is a third filtered sludge, and the third filtered sludge passes into the third collection chamber.

5. The water filtration system of claim 4, wherein the second treatment system further comprises:
a fourth collection chamber; and
a fourth porous pipe, arranged in the fourth collection chamber, comprising pores of a fourth porosity size and configured to receive the third filtered sludge from the third collection chamber, wherein the fourth porosity size is smaller than the third porosity size;
wherein the third filtered sludge is configured to flow through the pores of the fourth porous pipe and to provide a fourth filtered fluid into the fourth collection chamber while the pores of the third porous pipe block a fourth portion of the particulate matter comprising solid particulates greater in size than the fourth porosity size from passing through the fourth porous pipe.

6. The water filtration system as in any one of claims 2-5, wherein one or more of the first porous pipe, the second porous pipe, the third porous pipe and the fourth porous pipe are provided with a vibration transducer configured to vibrate the respective porous pipe.

7. The water filtration system as in any one of claims 2-5, wherein one or more of the first collection chamber, the second collection chamber, the third collection chamber and the fourth collection chamber are provided with a vibration transducer configured to vibrate the respective collection chamber.

8. The water filtration system as in any one of claims 2-5, wherein each of the first porous pipe, the second porous pipe, the third porous pipe and the fourth porous pipe comprise a pump system comprising one or more pumps and oscillators configured to create positive pulsing pressure pulling input into the respective porous pipe, and to create negative pulsing pressure pushing output from a preceding fluid source.

9. The water filtration system as in any one of claims 2-5, wherein one or more of the first collection chamber, the second collection chamber, the third collection chamber and the fourth collection chamber comprise an ultraviolet radiator therein.

10. The water filtration system as in any one of claims 2-5, wherein one or more of the first collection chamber, the second collection chamber, the third collection chamber and the fourth collection chamber comprise an aeration supply system therein, the aeration supply system comprising a further porous pipe configured to receive an input of air and provide the air through pores of the further porous pipe into the respective collection chamber.

11. The water filtration system as in any one of claims 2-5, wherein one or more of the first collection chamber, the second collection chamber, the third collection chamber and the fourth collection chamber comprise a chemical supply system therein, the chemical supply system comprising a further porous pipe configured to receive an input of one or more chemicals and provide the one or more chemicals through pores of the further porous pipe into the respective collection chamber.

12. The water filtration system as in any one of claims 2-5, wherein one or more of the first collection chamber, the second collection chamber, the third collection chamber and the fourth collection chamber comprise an aeration and chemical supply system therein, the aeration and chemical supply system comprising a further porous pipe configured to receive an input of air and one or more chemicals and provide the air and the one or more chemicals through pores of the further porous pipe into the respective collection chamber.

13. The water filtration system as in any one of claims 2-5, further comprising a tertiary treatment system receiving an input of the second filtered fluid, the third filtered fluid, or the fourth filtered fluid, and comprising one or more of an activated carbon filtration system, an ion exchange system, and a reverse osmosis system configured to process the input.

14. The water filtration system as in any one of claims 2-5, wherein each of the first porous pipe, the second porous pipe, the third porous pipe and the fourth porous pipe and the first collection chamber, the second collection chamber, the third collection chamber and the fourth collection chamber comprise a downward slope in a direction of fluid flow.

15. The water filtration system of claim 1, wherein the second filtered fluid is a second filtered sludge, and the second treatment system further comprises:
a third porous pipe, arranged around the second porous pipe, comprising pores of a third porosity size and configured to receive the second filtered sludge from the second porous pipe, wherein the third porosity size is smaller than the second porosity size;
wherein the second filtered sludge is configured to flow through the pores of the second porous pipe and to provide a third filtered fluid while the pores of the third porous pipe block a third portion of the particulate matter comprising solid particulates greater in size than the third porosity size from passing through the third porous pipe.

16. The water filtration system of claim 15, wherein the third filtered fluid is a third filtered sludge, and the second treatment system further comprises:
a fourth porous pipe, arranged around the third porous pipe, comprising pores of a fourth porosity size and configured to receive the third filtered sludge from the third porous pipe, wherein the fourth porosity size is smaller than the third porosity size;
wherein the third filtered sludge is configured to flow through the pores of the fourth porous pipe and to provide a fourth filtered fluid while the pores of the fourth porous pipe block a fourth portion of the particulate matter comprising solid particulates greater in size than the fourth porosity size from passing through the fourth porous pipe.

17. The water filtration system of claim 16, wherein the fourth filtered fluid passes into the second collection chamber.

18. The water filtration system as in any one of claim 1 or 15-17, wherein in one or more of the first porous pipe, the second porous pipe, the third porous pipe and the fourth porous pipe are provided with a vibration transducer configured to vibrate the respective porous pipe.

19. The water filtration system as in any one of claim 1 or 15-17, wherein in one or more of the first collection chamber and the second collection chamber are provided with a vibration transducer configured to vibrate the respective collection chamber.

20. The water filtration system as in any one of claim 1 or 15-17, wherein each of the first collection chamber and the second collection chamber comprise a pump system comprising one or more pumps and oscillators configured to create positive pulsing pressure pulling input into the respective collection chamber, and to create negative pulsing pressure pushing output from a preceding fluid source.

21. The water filtration system as in any one of claim 1 or 15-17, wherein in one or more of the first collection chamber and the second collection chamber comprise an ultraviolet radiator therein.

22. The water filtration system as in any one of claim 1 or 15-17, wherein in one or more of the first collection chamber and the second collection chamber comprise an aeration supply system therein, the aeration supply system comprising a further porous pipe configured to receive an input of air and provide the air through pores of the further porous pipe into the respective collection chamber.

23. The water filtration system as in any one of claim 1 or 15-17, wherein in one or more of the first collection chamber and the second collection chamber comprise a chemical supply system therein, the chemical supply system comprising a further porous pipe configured to receive an input of one or more chemicals and provide the one or more chemicals through pores of the further porous pipe into the respective collection chamber.

24. The water filtration system as in any one of claim 1 or 15-17, wherein in one or more of the first collection chamber and the second collection chamber comprise an aeration and chemical supply system therein, the aeration and chemical supply system comprising a further porous pipe configured to receive an input of air and one or more chemicals and provide the air and the one or more chemicals through pores of the further porous pipe into the respective collection chamber.

25. The water filtration system as in any one of claim 1 or 15-17, further comprising a tertiary treatment system receiving an input of the second filtered fluid, the third filtered fluid, or the fourth filtered fluid, and comprising one or more of an activated carbon filtration system, an ion exchange system, and a reverse osmosis system configured to process the input.

26. A water filtration method comprising:
a first treatment process comprising:
providing a water input comprising water and particulate matter to a first treatment system comprising a first collection chamber and a first porous pipe, arranged in the first collection chamber, comprising pores of a first porosity size and configured to receive the water input;
wherein the water input is configured to flow through the pores of the first porous pipe and provide a first filtered sludge into the first collection chamber while the pores of the first porous pipe block a first portion of the particulate matter comprising solid particulates greater in size than the first porosity size from passing into the first collection chamber; and
a second treatment process comprising:
providing the first filtered sludge to a second collection chamber and a second porous pipe, arranged in the second collection chamber, comprising pores of a second porosity size and configured to receive the first filtered sludge, wherein the second porosity size is smaller than the first porosity size;
wherein the first filtered sludge is configured to flow through the pores of the second porous pipe and to provide a second filtered fluid while the pores of the second porous pipe block a second portion of the particulate matter comprising solid particulates greater in size than the second porosity size from passing through the second porous pipe.

27. The water filtration method of claim 26, wherein the second filtered fluid is a second filtered sludge, and the second filtered sludge passes into the second collection chamber.

28. The water filtration method of claim 27, wherein the second treatment process further comprises providing the second filtered sludge from the second collection chamber to a third porous pipe arranged in a third collection chamber, the third porous pipe comprising pores of a third porosity size, wherein the third porosity size is smaller than the second porosity size;
wherein the second filtered sludge is configured to flow through the pores of the third porous pipe and to provide a third filtered fluid while the pores of the third porous pipe block a third portion of the particulate matter comprising solid particulates greater in size than the third porosity size from passing through the third porous pipe.

29. The water filtration method of claim 28, wherein the third filtered fluid is a third filtered sludge, and the third filtered sludge passes into the third collection chamber.

30. The water filtration method of claim 29, wherein the second treatment process further comprises providing the third filtered sludge from the third collection chamber to a fourth porous pipe arranged in a fourth collection chamber, the fourth porous pipe comprising pores of a fourth porosity size, wherein the fourth porosity size is smaller than the third porosity size;
wherein the third filtered sludge is configured to flow through the pores of the fourth porous pipe and to provide a fourth filtered fluid into the fourth collection chamber while the pores of the third porous pipe block a fourth portion of the particulate matter comprising solid particulates greater in size than the fourth porosity size from passing through the fourth porous pipe.

31. The water filtration method as in any one of claims 27-30, further comprising vibrating, by a vibration transducer arranged thereon, one or more of the first porous pipe, the second porous pipe, the third porous pipe and the fourth porous pipe.

32. The water filtration method as in any one of claims 27-30, further comprising vibrating, by a vibration transducer arranged thereon, one or more of the first collection chamber, the second collection chamber, the third collection chamber and the fourth collection chamber.

33. The water filtration method as in any one of claims 27-30, wherein each of the first porous pipe, the second porous pipe, the third porous pipe and the fourth porous pipe comprise a pump system comprising one or more pumps and oscillators configured to create positive pulsing pressure pulling input into the respective porous pipe, and to create negative pulsing pressure pushing output from a preceding fluid source.

34. The water filtration method as in any one of claims 27-30, further comprising providing ultraviolet radiation within one or more of the first collection chamber, the second collection chamber, the third collection chamber and the fourth collection chamber.

35. The water filtration method as in any one of claims 27-30, further comprising aerating, by an aeration supply system arranged therein, one or more of the first collection chamber, the second collection chamber, the third collection chamber and the fourth collection chamber, the aeration supply system comprising a further porous pipe configured to receive an input of air and provide the air through pores of the further porous pipe into the respective collection chamber.

36. The water filtration method as in any one of claims 27-30, supplying one or more chemicals into one or more of the first collection chamber, the second collection chamber, the third collection chamber and the fourth collection chamber, wherein the one or more chemicals are supplied by a chemical supply system arranged in the respective collection chamber, the chemical supply system comprising a further porous pipe configured to receive an input of the one or more chemicals and provide the one or more chemicals through pores of the further porous pipe into the respective collection chamber.

37. The water filtration method as in any one of claims 27-30, wherein one or more of the first collection chamber, the second collection chamber, the third collection chamber and the fourth collection chamber comprise an aeration and chemical supply system therein, comprising a further porous pipe configured to receive an input of air and one or more chemicals and provide the air and the one or more chemicals through pores of the further porous pipe into the respective collection chamber.

38. The water filtration method as in any one of claims 27-30, further comprising a tertiary treatment process comprising: processing one or more of the second filtered fluid, the third filtered fluid, or the fourth filtered fluid with one or more of an activated carbon filtration process, an ion exchange process, and a reverse osmosis process.

39. The water filtration method as in any one of claims 27-30, wherein each of the first porous pipe, the second porous pipe, the third porous pipe and the fourth porous pipe and the first collection chamber, the second collection chamber, the third collection chamber and the fourth collection chamber comprise a downward slope in a direction of fluid flow.

40. The water filtration method of claim 26, wherein the second filtered fluid is a second filtered sludge, and the second treatment process further comprises providing the second filtered sludge to a third porous pipe, arranged around the second porous pipe, comprising pores of a third porosity size wherein the third porosity size is smaller than the second porosity size;
wherein the second filtered sludge is configured to flow through the pores of the second porous pipe and to provide a third filtered fluid while the pores of the third porous pipe block a third portion of the particulate matter comprising solid particulates greater in size than the third porosity size from passing through the third porous pipe.

41. The water filtration method of claim 40, wherein the third filtered fluid is a third filtered sludge, and the second treatment process further comprises providing the third filtered sludge to a fourth porous pipe, arranged around the third porous pipe, comprising pores of a fourth porosity size, wherein the fourth porosity size is smaller than the third porosity size;
wherein the third filtered sludge is configured to flow through the pores of the fourth porous pipe and to provide a fourth filtered fluid while the pores of the fourth porous pipe block a fourth portion of the particulate matter comprising solid particulates greater in size than the fourth porosity size from passing through the fourth porous pipe.

42. The water filtration method of claim 41, wherein the fourth filtered fluid passes into the second collection chamber.

43. The water filtration method as in any one of claim 26 or 40-42, further comprising vibrating, by a vibration transducer arranged thereon, one or more of the first porous pipe, the second porous pipe, the third porous pipe and the fourth porous pipe.

44. The water filtration method as in any one of claim 26 or 40-42, further comprising vibrating, by a vibration transducer arranged thereon, one or more of the first collection chamber and the second collection chamber.

45. The water filtration method as in any one of claim 26 or 40-42, wherein each of the first collection chamber and the second collection chamber comprise a pump system comprising one or more pumps and oscillators configured to create positive pulsing pressure pulling input into the respective collection chamber, and to create negative pulsing pressure pushing output from a preceding fluid source.

46. The water filtration method as in any one of claim 26 or 40-42, further comprising providing ultraviolet radiation within one or more of the first collection chamber and the second collection chamber.

47. The water filtration method as in any one of claim 26 or 40-42, further comprising aerating, by an aeration supply system arranged therein, one or more of the first collection chamber and the second collection chamber, the aeration supply system comprising a further porous pipe configured to receive an input of air and provide the air through pores of the further porous pipe into the respective collection chamber.

48. The water filtration method as in any one of claim 26 or 40-42, supplying one or more chemicals into one or more of the first collection chamber and the second collection chamber, wherein the one or more chemicals are supplied by a chemical supply system arranged in the respective collection chamber, the chemical supply system comprising a further porous pipe configured to receive an input of the one or more chemicals and provide the one or more chemicals through pores of the further porous pipe into the respective collection chamber.

49. The water filtration method as in any one of claim 26 or 40-42, wherein in one or more of the first collection chamber and the second collection chamber comprise an aeration and chemical supply system therein, the aeration and chemical supply system comprising a further porous pipe configured to receive an input of air and one or more chemicals and provide the air and the one or more chemicals through pores of the further porous pipe into the respective collection chamber.

50. The water filtration method as in any one of claim 26 or 40-42, further comprising a tertiary treatment process comprising: processing one or more of the second filtered fluid, the third filtered fluid, or the fourth filtered fluid with one or more of an activated carbon filtration process, an ion exchange process, and a reverse osmosis process.
